(19) United States
(12) Patent Application Publication
(10) Pub. No.: US 2021/0027241 A1
(43) Pub. Date: Jan. 28, 2021

(54) INTEGRATED PLATFORM FOR PROGRAMMATIC INTERACTIONS FOR TRANSPORTATION SERVICES

(71) Applicant: Joseph Hunter Burke, Green Bay, WI (US)

(72) Inventor: Joseph Hunter Burke, Green Bay, WI (US)

(21) Appl. No.: 16/936,661

(22) Filed: Jul. 23, 2020

Related U.S. Application Data
(60) Provisional application No. 62/878,330, filed on Jul. 24, 2019.

(51) Int. Cl. G06Q 10/08; G06N 20/00

(52) U.S. Cl. CPC G06Q 10/0835; G06N 20/00

(57) ABSTRACT

Various embodiments further provide techniques for performing predictive data analysis using non-persistent-input machine learning models. Various embodiments provide techniques related to a platform for matching loads to carriers, such as techniques related to performing predictive data analysis tasks on the noted platform, including techniques for performing predictive data analysis using non-persistent-input machine learning models. In one example, a method includes generating the non-persistent-input machine learning model based on a persistently updated training data object and a joined periodic data object, where the joined periodic data object is determined by retrieving a plurality of periodically updated data objects from the plurality of periodically updated data sources, performing an aggregate join operation across the plurality of periodically updated data objects to generate an updated joined periodic data object, and updating a joined periodic data object in a storage medium based on the updated joined periodic data object.

### CROSS REFERENCE TO RELATED APPLICATIONS

This application is a conversion of provisional U.S. Patent Application No. 62/878,330, titled “Integrated Platform for Programmatic Interactions for Transportation Services,” filed Jul. 24, 2019, which is incorporated by reference herein in its entirety.

### BACKGROUND

The spot transportation market is a transportation market where the rates for transporting a load are agreed upon at or near the time of a shipment and are valid for only that one load. On average, across the industry, one person can book only seven loads in a day due to the large number of phone calls, emails, and faxes generally required to obtain transportation for a load at an optimal rate. Given how resource intensive procuring transportation for a load in the spot market is, traditionally brokers are enlisted to assist in procuring transportation for loads. However, the broker, as a middleman, adds further inefficiencies as being a barrier between direct communication between a shipper and a carrier and adds additional fees on top of the fees paid to the carrier.

### BRIEF SUMMARY OF SOME EXAMPLE EMBODIMENTS

Various embodiments of the present invention address technical challenges related to performing predictive data analysis using input data that is not persistently updated. Various embodiments of the present invention address the shortcomings of existing predictive data analysis systems and disclose various techniques for efficiently and reliably performing predictive data analysis using input data that is not persistently updated.

Various embodiments of the present invention provide methods, apparatus, systems, computer program products, and/or the like for performing predictive data analysis using input data that is not persistently updated. Example embodiments of such aspects utilize a non-persistent-input machine learning model in performing operations of an integrated platform for transportation. Certain embodiments of the present invention utilize systems, methods, and computer program products that perform predictive data analysis by utilizing a non-persistent-input machine learning model based on a persistently updated training data object and a joined periodic data object, where the joined periodic data object is determined by retrieving a plurality of periodically updated data objects from the plurality of periodically updated data sources, performing an aggregate join operation across the plurality of periodically updated data objects to generate an updated joined periodic data object, and updating a joined periodic data object in a storage medium based on the updated joined periodic data object.

In accordance with one aspect, a method is provided. In one embodiment, the method comprises: at an availability time associated with a plurality of periodically updated data sources, retrieving a plurality of periodically updated data objects from the plurality of periodically updated data sources; performing an aggregate join operation across the plurality of periodically updated data objects to generate an updated joined periodic data object; updating a joined periodic data object in a storage medium based, at least in part, on the updated joined periodic data object; causing a triggering event detection data object to detect one or more qualified updates to the joined periodic data object and, in response to detecting the one or more qualified updates, generate a training trigger event data object, wherein the training event data object defines a persistent data time window for one or more persistently updated data sources; generating a persistently updated data object by retrieving data from the one or more persistently updated data sources in accordance with the persistent data time window; generating a non-persistent-input machine learning model based, at least in part, on the persistently updated training data object and the joined periodic data object; and deploying the non-persistent-input machine learning model for performing one or more predictive inferences to generate one or more predictions and for performing one or more prediction-based actions based, at least in part, on the one or more predictions.

In accordance with another aspect, a computer program product is provided. The computer program product may comprise at least one computer-readable storage medium having computer-readable program code portions stored therein, the computer-readable program code portions comprising executable portions configured to: at an availability time associated with a plurality of periodically updated data sources, retrieve a plurality of periodically updated data objects from the plurality of periodically updated data sources; perform an aggregate join operation across the plurality of periodically updated data objects to generate an updated joined periodic data object; update a joined periodic data object in a storage medium based, at least in part, on the updated joined periodic data object; cause a triggering event detection data object to detect one or more qualified updates to the joined periodic data object and, in response to detecting the one or more qualified updates, generate a training trigger event data object, wherein the training event data object defines a persistent data time window for one or more persistently updated data sources; generate a persistently updated data object by retrieving data from the one or more persistently updated data sources in accordance with the persistent data time window; generate a non-persistent-input machine learning model based, at least in part, on the persistently updated training data object and the joined periodic data object; and deploy the non-persistent-input machine learning model for performing one or more predictive inferences to generate one or more predictions and for performing one or more prediction-based actions based, at least in part, on the one or more predictions.

In accordance with yet another aspect, an apparatus comprising at least one processor and at least one memory including computer program code is provided. In one embodiment, the at least one memory and the computer program code may be configured to, with the processor, cause the apparatus to: at an availability time associated with a plurality of periodically updated data sources, retrieve a plurality of periodically updated data objects from the plurality of periodically updated data sources; perform an aggregate join operation across the plurality of periodically updated data objects to generate an updated joined periodic data object; update a joined periodic data object in a storage medium based, at least in part, on the updated joined periodic data object; cause a triggering event detection data object to detect one or more qualified updates to the joined periodic data object and, in response to detecting the one or more qualified updates, generate a training trigger event data object, wherein the training event data object defines a persistent data time window for one or more persistently updated data sources; generate a persistently updated data object by retrieving data from the one or more persistently updated data sources in accordance with the persistent data time window; generate a non-persistent-input machine learning model based, at least in part, on the persistently updated training data object and the joined periodic data object; and deploy the non-persistent-input machine learning model for performing one or more predictive inferences to generate one or more predictions and for performing one or more prediction-based actions based, at least in part, on the one or more predictions.

Various embodiments of the present invention provide methods, apparatus, systems, computer program products, and/or the like for an integrated platform for transportation. In various embodiments, the platform is integrated with a shipper's transportation management system (TMS) and/or a carrier's operational management system (OMS). For example, a shipper client of the platform may be configured to be integrated into a shipper's TMS, provide an integrated experience (e.g., user experience via an interactive user interface (IUI)) with the shipper's TMS, and/or the like. In various embodiments, the integration of the shipper client with the shipper's TMS is accomplished via a plug-in to the shipper's TMS, one or more application programming interfaces (APIs), and/or the like. Similarly, a carrier client of the platform may be configured to be integrated into a carrier's OMS, provide an integrated experience (e.g., user experience via an IUI) with the carrier's OMS, take the place of at least a portion of the carrier's OMS, and/or the like. In various embodiments, the integration of the carrier client with the carrier's OMS is accomplished via a plug-in to the carrier's OMS, one or more APIs, and/or the like.

In various embodiments, a shipping user is a user (human or machine user) operating a shipping computing entity on behalf of shipper (e.g., an individual, organization, department of an organization, and/or the like) that is shipping one or more loads of one or more items. A shipping user may submit a load posting to the platform (e.g., via the shipper's TMS). The load posting indicates a pick-up location and a delivery location of a load. The load posting may further indicate a pick-up time or pick-up time window, a delivery time or delivery time window, special handling instructions, information/data regarding the equipment required/desired for transporting the load, shipper contact information/data, and/or the like. The shipper may also submit a transportation fee value that the shipper is willing to pay for transportation of the load. In an example embodiment, the load posting may be associated with a preferred set of carriers (e.g., carriers selected by a shipper user and/or based on carrier ratings), as indicated via user input or by preferences stored in the corresponding shipper profile.

In various embodiments, a carrier user is a user (human or machine user) operating a carrier computing entity on behalf of a carrier (e.g., an individual, organization, department of an organization, and/or the like) that provides transportation services for transporting loads from corresponding pick-up locations to delivery locations. A carrier user may browse or search load postings to identify loads for which the carrier would like to provide transportation services. The carrier user may then book one or more loads and then proceed with providing the transportation of the one or more booked loads from the corresponding pick-up locations to the delivery locations. In various embodiments, one or more carriers may have contracts with one or more shippers indicating an agreed upon price (e.g., a contract transportation fee value) for transporting one or more loads during a particular time frame. When a carrier user associated with a carrier that has a contract with a shipper views load postings associated with the shipper (e.g., via a carrier IUI), the carrier user is only provided with load postings associated with the shipper that have a transportation fee value that is greater than or equal to the contract transportation fee value of the corresponding contract. When a carrier user associated with a carrier that has a contract with a shipper views load postings associated with the shipper and the transportation fee value is greater than the contract transportation fee value of the corresponding contract, the contract transportation fee value of the corresponding contract is shown to the carrier user (e.g., via a carrier IUI), in an example embodiment. In various embodiments, a shipper user may choose whether to allow a carrier to view the spot rate when the spot rate is at, or above, the contracted rate or to only view the contracted rate. In various embodiments, if a load posting is associated with a preferred set of carriers (e.g., the metadata or header of the load posting may include information/data identifying a preferred set of carriers, the shipper profile corresponding to the shipper may indicate a preferred set of carriers, and/or the like), the load posting will only be provided to carrier users associated with a carrier of the preferred set of carriers.

In various embodiments, the transportation fee value of a load posting may be a dynamic, automatically determined value (e.g., determined by a computing platform) based on various details regarding the load, the load posting, and a shipper profile corresponding to the shipper associated with the load posting. For example, the transportation fee value may be dynamically and/or automatically determined based on pricing based on triggers such as views of the load posting by carrier users, clicks/interactions by carrier users on the load posting or similar load postings, capacity of one or more carriers, delivery time and/or time window date, contracted rates, timing, the shipper profile corresponding to the shipper, and/or the like.

In various embodiments, a carrier user may establish one or more preferred load criteria (e.g., by adding preferred load criteria information/data to a corresponding carrier profile). When a new load posting is received and/or processed by the computing platform, the computing platform may determine if the load posting satisfies the preferred load criteria of one or more carriers. If the new load posting satisfies the preferred load criteria of one or more carriers, one or more preferred load notifications/indications may be generated and provided to one or more carrier computing entities (and/or one or more electronic delivery addresses indicated in the corresponding carrier profile).

In various embodiments, when a carrier user books a load, one or more load postings corresponding to complementary loads may be provided (e.g., via the carrier IUI) to the carrier user. In various embodiments, a complementary load of a first load may be a load that has a substantially opposite pick-up and delivery locations from the first load with complementary a pick-up time/window and delivery time/window. For example, if the first load had a pick-up location of Atlanta, Ga., a delivery location of Birmingham, Ala., and a delivery time of 12 pm CT, a complementary load may have a pick-up location of Trussville, Ala., a pick-up time of 2 pm CT, and a delivery location of Doraville, Ga. In various embodiments, when a carrier user books a second load, one or more load postings corresponding to complementary loads to the second load or one or more first loads previously booked by the carrier user (or another carrier user associated with the same carrier) may be provided (e.g., via the carrier IUI) to the carrier user. For example, a first load may have a delivery location of Atlanta, Ga., and a second load may have a pick-up location of Knoxville, Tenn. A complementary load to the first load and the second load may have a pick-up location of Roswell, Ga., and a delivery location of Maryville, Tenn., with a pick-up time/window that permits the delivery of the first load to the first load delivery location, travel from the first load delivery location to the complementary load pick-up location, and any required rest (e.g., to ensure a driver (or driver team) driving the first load, complementary load, and second load does not surpass a maximum consecutive driving time) and a delivery time/window that permits delivery of the complementary load to the associated delivery location, travel time from the complementary load delivery location to the second load pick-up location, and any required rest. A carrier profile may include information/data corresponding to carrier preferences regarding time between first load delivery time/window and complementary load pick-up time/window and/or between complementary load delivery time/window and second load pick-up time/window used to identify complementary loads to be provided (e.g., via the carrier IUI) to a carrier user associated with the carrier corresponding to the carrier profile.

In various embodiments, after a carrier user books a load, the carrier proceeds to transport the load from the pick-up location to the delivery location in accordance with the pick-up time or time window and the delivery time or time window. In various embodiments, the computing platform may receive and store load transportation information/data as the load is transported from the pick-up location to the destination location. In various embodiments, the computing platform may make the load transportation information/data available to one or more shipper computing entities such that a shipper user may access the shipper client to view information/data regarding the transportation of the load, possibly while the transportation of the load is in progress. In various embodiments, when the load transportation information/data indicates that a transportation benchmark has been accomplished (e.g., the load has been delivered, the load has been delivered and checked in by a receiver, and/or the like), the computing platform may cause the payment in the amount of the transportation fee value and/or a corresponding agreed upon contract rate to be debited from a shipper account associated with the shipper and credited to a carrier account associated with the carrier.

### BRIEF DESCRIPTION OF THE DRAWINGS

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a computing platform, according to an example embodiment of the present invention.

FIG. 3 is an exemplary schematic diagram of a shipper computing entity and/or a carrier computing entity, according to an example embodiment of the present invention.

FIG. 4 provides a schematic diagram of an example software architecture that may be used to practice an example embodiment of the present invention.

FIG. 5 provides a flowchart illustrating example processes, procedures, and/or operations performed by a computing platform, for example, for providing a platform for transportation, according to an example embodiment of the present invention.

FIG. 6 provides a flowchart illustrating example processes, procedures, and/or operations performed by a shipper computing entity, for example, for providing a shipper IUI, according to an example embodiment of the present invention.

FIGS. 7 and 8 each provide an example view of a shipper IUI, according to an example embodiment of the present invention.

FIG. 9 provides a flowchart illustrating example processes, procedures, and/or operations performed by a carrier computing entity, for example, for providing a carrier IUI, according to an example embodiment of the present invention.

FIGS. 10, 11, 12, 13, 14, 15, 16, 17, 18, 19A, 19B, 19C, 19D, 19E, 20A, 20B, 20C, and 20D each provide an example view of a carrier IUI, according to an example embodiment of the present invention.

FIG. 21 provides an operational example of data extraction from three data sources in accordance with some embodiments discussed herein.

FIG. 22 is a flowchart diagram of an example process for performing predictive data analysis using a non-persistent-input machine learning model in accordance with some embodiments discussed herein.

FIG. 23 is a flowchart diagram of an example process for generating a joined periodic data object in accordance with some embodiments discussed herein.

FIG. 24 is a flowchart diagram of an example process for generating a non-persistent-input machine learning model in accordance with some embodiments discussed herein.

FIG. 25 is a flowchart diagram of an example process for deploying a trained non-persistent-input machine learning model in accordance with some embodiments discussed herein.

FIG. 26 is a flowchart diagram of performing predictive inferences using a deployed non-persistent-input machine learning model in accordance with some embodiments discussed herein.

FIG. 27 provides an operational example of a predictive output user interface in accordance with some embodiments discussed herein.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview

Various embodiments of the present invention provide methods, apparatus, systems, computer program products, and/or the like for an integrated platform for transportation. In various embodiments, the platform may be provided via the execution of application program code, computer executable code, and/or the like configured to cause one or more computing entities (e.g., a computing platform, shipper computing entity, carrier computing entity and/or the like) to perform various functions described herein. In various embodiments, the platform receives load postings each corresponding to a request for transportation of a load of one or more items from a pick-up location to a delivery location.

In various embodiments, the platform is integrated with a shipper's TMS and/or a carrier's OMS. For example, a shipper client of the platform may be configured to be integrated into a shipper's TMS, provide an integrated experience (e.g., user experience via an IUI) with the shipper's TMS, and/or the like. In various embodiments, the integration of the shipper client with the shipper's TMS is accomplished via a plug-in to the shipper's TMS, one or more APIs, and/or the like. Similarly, a carrier client of the platform may be configured to be integrated into a carrier's OMS, provide an integrated experience (e.g., user experience via an IUI) with the carrier's OMS, take the place of at least a portion of the carrier's OMS, and/or the like. In various embodiments, the integration of the carrier client with the carrier's OMS is accomplished via a plug-in to the carrier's OMS, one or more APIs, and/or the like.

In various embodiments, a shipping user is a user (human or machine user) operating a shipping computing entity on behalf of shipper (e.g., an individual, organization, department of an organization, and/or the like) that is shipping one or more loads of one or more items. A shipping user may submit a load posting to the platform (e.g., via the shipper's TMS). The load posting indicates a pick-up location and a delivery location of a load. The load posting may further indicate a pick-up time or pick-up time window, a delivery time or delivery time window, special handling instructions, information/data regarding the equipment required/desired for transporting the load, payment information/data for the load (e.g., at what benchmark(s)) is payment made from the shipper to the carrier for the carrier's service in transporting the load, the amount of payment to be made at a benchmark, and/or the like), and/or other pertinent information/data regarding the load and/or transportation of the load. The shipper may also submit a transportation fee value that the shipper is willing to pay for transportation of the load. In an example embodiment, the load posting may be associated with a preferred set of carriers, as indicated via user input or by preferences stored in the corresponding shipper profile.

In various embodiments, a carrier user is a user (human or machine user) operating a carrier computing entity on behalf of a carrier (e.g., an individual, organization, department of an organization, and/or the like) that provides transportation services for transporting loads from corresponding pick-up locations to delivery locations. A carrier user may browse or search load postings to identify loads for which the carrier would like to provide transportation services. The carrier user may then book one or more loads and then proceed with providing the transportation of the one or more booked loads from the corresponding pick-up locations to the delivery locations. In various embodiments, one or more carriers may have contracts with one or more shippers indicating an agreed upon price (e.g., contract transportation fee value) for transporting one or more loads during a particular time frame. When a carrier user associated with a carrier that has a contract with a shipper views load postings associated with the shipper (e.g., via a carrier IUI), the carrier user is only provided with load postings associated with the shipper that have a transportation fee value that is greater than or equal to the contract transportation fee value of the corresponding contract. When a carrier user associated with a carrier that has a contract with a shipper views load postings associated with the shipper and the transportation fee value is greater than the contract transportation fee value of the corresponding contract, the contract transportation fee value of the corresponding contract is shown to the carrier user (e.g., via a carrier IUI). In various embodiments, if a load posting is associated with a preferred set of carriers (e.g., the metadata or header of the load posting may include information/data identifying a preferred set of carriers, the shipper profile corresponding to the shipper may indicate a preferred set of carriers, and/or the like), the load posting will only be provided to carrier users associated with a carrier of the preferred set of carriers.

In various embodiments, the transportation fee value of a load posting may be a dynamic, automatically determined value (e.g., determined by a computing platform) based on various details regarding the load, the load posting, and a shipper profile corresponding to the shipper associated with the load posting. For example, the transportation fee value may be dynamically and/or automatically determined based on pricing based on triggers such as views of the load posting by carrier users, clicks/interactions by carrier users on the load posting or similar load postings, capacity of one or more carriers, delivery time and/or time window date, contracted rates, timing, the shipper profile corresponding to the shipper, and/or the like.

In various embodiments, a carrier user may establish one or more preferred load criteria (e.g., by adding preferred load criteria information/data to a corresponding carrier profile). When a new load posting is received and/or processed by the computing platform, the computing platform may determine if the load posting satisfies the preferred load criteria of one or more carriers. If the new load posting satisfies the preferred load criteria of one or more carriers, one or more preferred load notifications/indications may be generated and provided to one or more carrier computing entities (and/or one or more electronic delivery addresses indicated in the corresponding carrier profile).

In various embodiments, when a carrier user books a load, one or more load postings corresponding to complementary loads may be provided (e.g., via the carrier IUI) to the carrier user. In various embodiments, a complementary load of a first load may be a load that has a substantially opposite pick-up and delivery locations from the first load with complementary a pick-up time/window and delivery time/window. For example, if the first load had a pick-up location of Atlanta, Ga., a delivery location of Birmingham, Ala., and a delivery time of 12 pm CT, a complementary load may have a pick-up location of Trussville, Ala., a pick-up time of 2 pm CT, and a delivery location of Doraville, Ga. In various embodiments, when a carrier user books a second load, one or more load postings corresponding to complementary loads to the second load or one or more first loads previously booked by the carrier user (or another carrier user associated with the same carrier) may be provided (e.g., via the carrier IUI) to the carrier user. For example, a first load may have a delivery location of Atlanta, Ga., and a second load may have a pick-up location of Knoxville, Tenn. A complementary load to the first load and the second load may have a pick-up location of Roswell, Ga., and a delivery location of Maryville, Tenn., with a pick-up time/window that permits the delivery of the first load to the first load delivery location, travel from the first load delivery location to the complementary load pick-up location, and any required rest (e.g., to ensure a driver (or driver team) driving the first load, complementary load, and second load does not surpass a maximum consecutive driving time) and a delivery time/window that permits delivery of the complementary load to the associated delivery location, travel time from the complementary load delivery location to the second load pick-up location, and any required rest. A carrier profile may include information/data corresponding to carrier preferences regarding time between first load delivery time/window and complementary load pick-up time/window and/or between complementary load delivery time/window and second load pick-up time/window used to identify complementary loads to be provided (e.g., via the carrier IUI) to a carrier user associated with the carrier corresponding to the carrier profile.

In various embodiments, after a carrier user books a load, the carrier proceeds to transport the load from the pick-up location to the delivery location in accordance with the pick-up time or time window and the delivery time or time window and any other instructions provided in the load posting. In various embodiments, the computing platform may receive and store load transportation information/data as the load is transported from the pick-up location to the destination location. In various embodiments, the computing platform may make the load transportation information/data available to one or more shipper computing entities such that a shipper user may access the shipper client to view information/data regarding the transportation of the load, possibly while the transportation of the load is in progress. In various embodiments, when the load transportation information/data indicates that a transportation benchmark has been accomplished (e.g., the load has been delivered, the load has been delivered and checked in by a receiver, and/or the like), the computing platform may cause the payment in the amount of the transportation fee value and/or a corresponding agreed upon contract rate to be debited from a shipper account associated with the shipper and credited to a carrier account associated with the carrier.

To address the challenges associated with efficiency and reliability of performing predictive data analysis using non-persistent input data, various embodiments of the present invention introduce techniques that retrieve both persistently updated training data and non-persistently updated training data (e.g., periodically updated training data) in accordance with the latest availability time of the non-persistently updated training data sources. For example, in some embodiments, at a latest availability time of the non-persistently updated training data sources, such non-persistently-updated training data is joined with persistently updated training data having timestamps that predate the latest availability time in order to generate a non-persistent-input machine learning model. The resulting machine learning model is thus only trained only on a portion of the persistently updated training data that would have been generated by the latest update time of the non-persistently updated training data.

Accordingly, in various embodiments, the integrated platform for transportation uses a non-persistent input machine learning model. However, while various embodiments of the present invention disclose using a non-persistent input machine learning model, a person of ordinary skill in the relevant technology will recognize that the disclosed non-persistent-input machine learning model can be used in relation to other use cases. For example, the disclosed non-persistent-input machine learning model can be used in relation to a predictive data analysis system configured to generate preferred load criteria, a predictive data analysis system configured to generate repair need predictions, a predictive data analysis system configured to generate maintenance need predictions, a predictive data analysis system configured to generate fraud detection predictions, a predictive data analysis system configured to generate estimated quality metrics, a predictive data analysis system configured to generate optimal quality metrics, and/or the like.

### Definitions

The term “load database” may refer to a data object that is configured to describe a group of one or more load postings. Examples of load databases including relational load databases, graph-based load databases, object-oriented load databases, non-structured load databases (e.g., NoSQL load databases), and/or the like. In some embodiments, a load database is determined based on historical data associated with a group of historical transportation-related transactions. In some embodiments, at least a portion of a load database may be determined based on extrapolations performed using both historical data associated with a group of historical transportation-related transactions as well as transportation metadata retrieved from one or more transportation market metadata data sources.

The term “carrier database” may refer to a data object that is configured to describe carrier feature information associated with a group of one or more carrier profiles. Examples of load databases including relational carrier databases, graph-based carrier databases, object-oriented carrier databases, non-structured carrier databases (e.g., NoSQL load databases), and/or the like. In some embodiments, a load database is determined based on historical data associated with a group of historical transportation-related transactions. In various embodiments, after the carrier user has entered, provided, and/or selected the carrier profile information/data, the carrier profile information/data is provided to a computing platform and stored in the carrier database. For example, if a carrier profile does not yet exist for the shipper in the carrier database, a new carrier profile may be generated based on the carrier user entered, provided, and/or selected carrier profile information/data and the generated carrier profile may be stored in the carrier database. If a carrier profile does already exist in the carrier database, the existing carrier profile may be updated based on the carrier user entered, provided, and/or selected carrier profile information/data. Various embodiments of the present invention enable advantages of providing carrier users with notification when a load that satisfies a carrier's preferred load criteria is posted and/or providing carrier users with complementary load postings that complement loads already booked by the carrier.

The term “load posting” may refer to a data object that describes one or more metadata features (e.g., temporal metadata features, geographic metadata features, and/or the like) about a transportation load entry. For example, the metadata features for a load may include a pick-up location, pick-up time/window, delivery location, delivery time/window, special handling instructions, information/data regarding the equipment required/desired for transporting the load, and/or the like. In an example embodiment, the pick-up location may be a street address, geolocation, landmark, and/or any other identifiable location at which the load is to be picked up from by the carrier. In an example embodiment, the pick-up time/window is a date and time and/or a period of time during one or more dates during which the carrier is to pick up the load from the pick-up location. In an example embodiment, the delivery location may be a street address, geolocation, landmark, and/or any other identifiable location at which the load is to be delivered to by the carrier. In an example embodiment, the delivery time/window is a date and time and/or a period of time during one or more dates during which the carrier is to deliver the load to the delivery location.

The term “preferred load criteria” may refer to a data object that is configured to describe load preference data and/or recommended load preference data for a transportation load entry. For instance, the preferences information/data may indicate preferred load criteria (e.g., load types, lanes, and/or the like) used by a preferred load engine to identify preferred loads for the carrier, used by a complementary load engine to identify complementary loads for the carrier, and/or the like. The preferences information/data may include payment preferences, shipper-carrier contract information/data for contracts associated with the carrier, one or more home bases for the carrier (and/or drivers that work for the carrier), and/or the like. In various embodiments, the preferred load criteria and/or complementary load criteria may be received via user input or learned (e.g., using machine learning) through monitoring carrier behavior (e.g., loads booked, and/or the like) and/or a combination thereof. In various embodiments, after the carrier user has entered, provided, and/or selected the carrier profile information/data, the carrier profile information/data is provided to a computing platform and stored in the carrier database. For example, if a carrier profile does not yet exist for the shipper in the carrier database, a new carrier profile may be generated based on the carrier user entered, provided, and/or selected carrier profile information/data and the generated carrier profile may be stored in the carrier database. If a carrier profile does already exist in the carrier database, the existing carrier profile may be updated based on the carrier user entered, provided, and/or selected carrier profile information/data. Various embodiments of the present invention enable advantages of providing carrier users with notification when a load that satisfies a carrier's preferred load criteria is posted and/or providing carrier users with complementary load postings that complement loads already booked by the carrier.

The term “dynamic transportation fee value” may refer to a data object that is configured to describe an estimated/predicted utility value for a transportation load entry, where the estimated/predicted utility value may be determined based on runtime-extracted data generated at a time associated with generating the estimated/predicted utility value. In some embodiments, the shipper user operating a shipper computing entity may provide and/or select a transportation fee value for transporting the load (e.g., based on the pricing information/data) and/or select a dynamic pricing option. In some of the noted embodiments, the shipper computing entity may then provide the load posting such that the computing platform 10 receives the load posting. In some embodiments, dynamic transportation fee value is determined based on one or more of (a) transportation fee values associated with one or more load postings having at least partially overlapping transportation paths, (b) transportation fee values associated with one or more load postings having at least partially overlapping transportation periods, (c) an amount of time between the current time and the pick-up time/window, (d) a volume of load postings having transportation periods that at least partially overlap with the transportation period of the first load, (e) a volume of load postings having transportation paths that at least partially overlap with the transportation path of the first load, (f) a number of times the load posting corresponding to the first load has been provided to a carrier computing entity, (g) a rating associated with the shipper, or (h) a rating associated with the carrier. Various embodiments of the present invention provide for dynamically and automatically determining a transportation fee value (and/or a suggestion thereof) to be paid by the shipper to the carrier for transportation of the load. The dynamic determination of the transportation fee value to be provided to a carrier as part of the load posting allows for dynamic market features to be reflected in real-time or near real-time in the provided transportation fee values.

The term “joined periodic data object” may refer to a data object that is configured to describe features derived by extracting periodically updated data objects from a group of periodically updated data sources and performing an aggregate join operation across the periodically updated data objects. For example, a joined periodic data object may be generated by extracting market-level feature data associated with various trucking markets from two trucking data sources and performing a market-level aggregate join operation. In the noted example, the joined periodic data object may describe, for each trucking market of the various trucking markets, extracted features that include both the features described by the first trucking database and the features described by the second trucking database, as well as optionally features inferred by performing cross-database inferences across the features described by the first trucking database and the features described by the second trucking database.

The term “crawler workflow” may refer to a computer-implemented process that is configured to extract data from a group of data sources and use the extracted data to generate an extracted data frame that is configured to be stored on a predefined storage medium. An example of a crawler workflow is an Amazon Web Services (AWS) Glue workflow. In some embodiments, the crawler workflow is triggered at a workflow initiation time, where the workflow initiation time describes a predefined time interval associated with triggering the crawler workflow. For example, in some embodiments, the workflow initiation time for a crawler may describe a time period within which the crawler workflow is triggered in order to extract data from the group of data sources. The group of data sources whose corresponding data is extracted by a crawler workflow may include one or more periodically updated data sources and one or more persistently updated data sources. In some embodiments, given a particular crawler workflow that is associated with a group of data sources that include a group of periodically updated data sources, the workflow initiation time for the particular crawler workflow is determined based on the availability time of the group of periodically updated data sources associated with the particular crawler workflow.

The term “periodically updated data source” may refer to a computer system that is configured to transmit updated data with a defined periodicity, such that the data transmitted by the periodically updated data source prior to an update time defined by the defined periodicity of the periodically updated data source is deemed outdated. For example, a periodically updated data source may be a data source that provides updated data after a particular time interval during each day, such as after 5 PM each day. Examples of periodically updated data sources include the Dial-a-Truck (DAT) data servers as well as the SONAR data server provided by FreightWaves. In general, in some embodiments, periodically updated data sources may include external data sources deemed remote/foreign to a data-retrieving computing platform, such that the data-retrieving computing platform does not exercise control over data updates provided by the periodically updated data sources. This lack of control in turn requires fine-tuning the data preprocessing and training processes of a non-persistent-input machine learning model executed by the data-retrieving computing platform in order to accommodate the non-persistent nature of the availability of the corresponding training data.

The term “persistently updated data source” may refer to a computer system configured that is configured to transmit updated data in real-time (i.e., in response to detecting updates in the underlying data). Thus, unlike the data transmitted by a periodically updated data source, the data transmitted by a persistently updated data source is not associated with a defined periodicity, and is therefore deemed to be updated at any time of retrieval. An example of a persistently updated data source is an internal/local data source over which the computing platform 10 exercises control. An example of a persistently updated data source is the Loadshop data source maintained internally by KBX Logistics.

When used in relation to a group of periodically updated data sources, the term “availability time” of the noted group of periodically updated data sources may refer to a data object that describes a time that is deemed to be subsequent to each update time associated with a target period of a periodically updated data source in the group of periodically updated data sources, where the target period of the periodically updated data source may be the earliest period of time whose corresponding updated data has not been extracted by a data-retrieving computing platform. For example, given a set of periodically updated data sources that consist of a first periodically updated data source that is updated daily at 12 PM and a second periodically updated data source that is updated daily at 2 PM, the availability time of the given group of periodically updated data sets that is used to determine the workflow initiation time of a crawler workflow associated with the given set of periodically updated data sources may be 3 PM. As another example, given a set of periodically updated data sources that consists of a first periodically updated data source that is updated weekly on Fridays at 1 PM and whose updated data has last been retrieved on Jun. 12, 2020 as well as a second periodically updated data source that is updated daily at 11 PM and whose updated data has last been retrieved on Jun. 18, 2020, the availability time of the given group of periodically updated data sets that is used to determine the workflow initiation time of a crawler workflow associated with the given set of periodically updated data sources may be 12 AM on Jun. 20, 2020.

The term “metadata catalog” may refer to a data object that includes references to data extracted using a crawler workflow as well as an inferred schema of the data as determined by the crawler workflow. An example of a metadata catalog is the AWS Glue Data Catalog that includes metadata tables, where the metadata tables include, for each extracted data file of a group of extracted data files, a reference to the extracted data file on an internally managed data store (e.g., an Amazon S3 data source), an inferred metadata of the extracted data file, and an inferred classification of the extracted file, where the inferred metadata of an extracted data file and the inferred classification of an extracted data file may be determined using an AWS Glue Workflow. In some embodiments, a metadata catalog may be used to access previously extracted data associated with a group of data sources in order to compare the previously extracted data and recently extracted data associated with the group of data sources. In some of the noted embodiments, in response to determining changes between the previously extracted data and recently extracted data associated with the group of data sources, the updated data may be stored on an internally managed storage medium and the metadata catalog may be updated to reflect updated references to the updated data and/or to reflect updated metadata for the updated data.

The term “aggregate join operation” may refer to a computer-implemented process that is configured to join data entries described by two or more input data objects (e.g., a data object containing data extracted from a first periodically updated data source and a data object containing data extracted from a second periodically updated data source) across common data associations. For example, the aggregate join operation performed on a first data object containing SONAR data and a second data object containing DAT data may merge data entries from the two data objects that correspond to common markets/geographical regions, thus creating a resultant merged joined data object that describes both SONAR-based features and DAT-based features for a particular market/geographical region.

The term “non-persistent-input machine learning model” may refer to a data object that describes parameters and/or hyper-parameters of a machine learning model that is configured to be trained using training data derived based at least in part using data extracted from at least one periodically updated data source. Because of the non-persistent nature of the input training data for the noted non-persistent-input machine learning models, training such non-persistent-input machine learning models presents unique challenges in terms of both appropriately adjusting the timing of retrieval of periodically updated as well as setting the temporality of the persistently updated data in order to provide temporal compatibility across the periodically updated data and persistently updated data. An example of a non-persistent-input machine learning model is a machine learning model that is configured to generate an optimal price for a proposed transportation load based on joined periodic data generated using SONAR data and DAT data as well as using persistently updated Loadshop data.

The term “training event detection data object” may refer to a data object that describes operations that, when executed, cause detecting any qualified changes to a joined periodic data object and generating a training triggering event in response to detecting at least one qualified change to the joined periodic data object. In some embodiments, the triggering event detection data object is configured to generate a training triggering event in response to detecting any changes to a joined period data object. In some embodiments, the triggering event detection data object is configured to generate a particular training triggering event in response to detecting one or more predefined changes to a joined periodic data object, such as changes to particular data fields of the joined periodic data object, changes to the schema of the joined periodic data object, and/or changes to the data storage metadata associated with the noted joined periodic data object.

The term “training triggering event” may refer to a data object that describes a recommendation for training a non-persistent-input machine learning model in accordance with the training configuration data associated with a training configuration data object that is referenced by the training triggering event as well as a persistent data time window described by the training triggering event. As noted above, a training triggering event may be generated by executing operations defined by a training event detection data object, where the noted operations define qualified changes to a joined periodic data object that cause a need for retraining the non-persistent-input machine learning model. In some embodiments, the training configuration data described by a training triggering event describe at least one parameter, at least hyper-parameter, and/or at least one operation of a training process configured to generate the non-persistent-input machine learning model based on training data that includes a joined periodic data object as well as data extracted from a group of one or more persistently updated data sources.

The term “persistent data time window” may refer to a data object that describes a range of timestamps associated with persistently updated data entries extracted from a group of persistently updated data sources, where the group of persistently updated data sources are deemed related to a training event, and where the training event is recommended by the training triggering event. For example, a particular training triggering event may describe that only persistently updated data having timestamps up to a certain point in time are deemed related to a corresponding training event, where the certain point in time is defined by the persistent data time window. In some embodiments, the persistent data time window is determined based, at least in part, on the availability time of the group of periodically updated data sources used to generate the joined periodic data object. For example, in some embodiments, the upper bound of the persistent data time window is the availability time. As another example, in some embodiments, the upper bound of the persistent data time window is the endpoint of a latency period following the availability time.

### Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

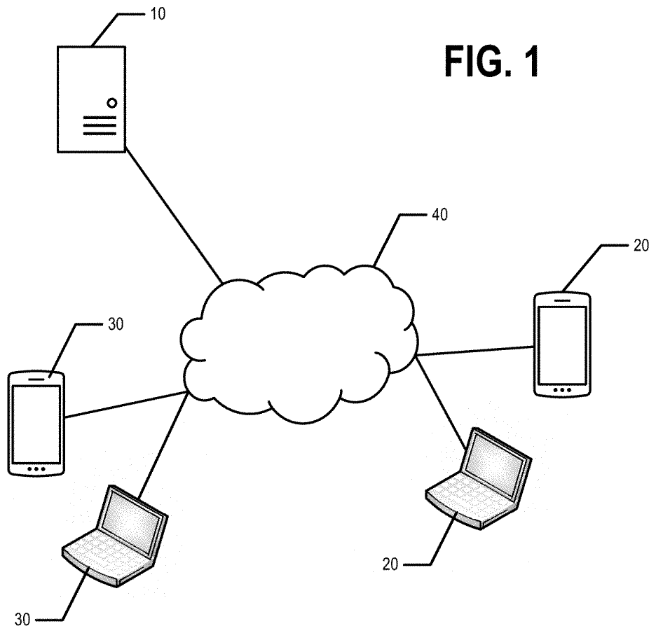

FIG. 1 provides an illustration of an exemplary embodiment of the present invention. As shown in FIG. 1, this particular embodiment may include one or more computing platforms 10, one or more shipper computing entities 20, one or more carrier computing entities 30, and/or one or more networks 40. The computing platform 10, shipper computing entity 20, and/or carrier computing entity 30 may be in direct or indirect communication with, for example, one another over the same or different wired or wireless networks 40. Additionally, while FIG. 1 illustrates the various system entities as separate, standalone entities, the various embodiments are not limited to this particular architecture.

In some embodiments, the computing platform 10 may be configured to process the predictive data analysis requests to generate predictions, provide the generated predictions to the shipper computing entity 20 and/or the carrier computing entity 30, and automatically perform prediction-based actions based, at least in part, on the generated predictions. Examples of predictive inferences that may be performed by the computing platform 10 include generating optimal price recommendations for truck loads.

In some embodiments, the computing platform 10 may communicate with at least one of to the shipper computing entity 20 and/or the carrier computing entity 30 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

In some embodiments, the computing platform 10 may include a storage subsystem, where they may be configured to store input data used by the computing platform 10 to perform predictive data analysis as well as model definition data used by the computing platform 10 to perform various predictive data analysis tasks. The storage subsystem 108 may include one or more storage units, such as multiple distributed storage units that are connected through a computer network. Each storage unit in the storage subsystem may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede

### 1. Exemplary Computing Platform

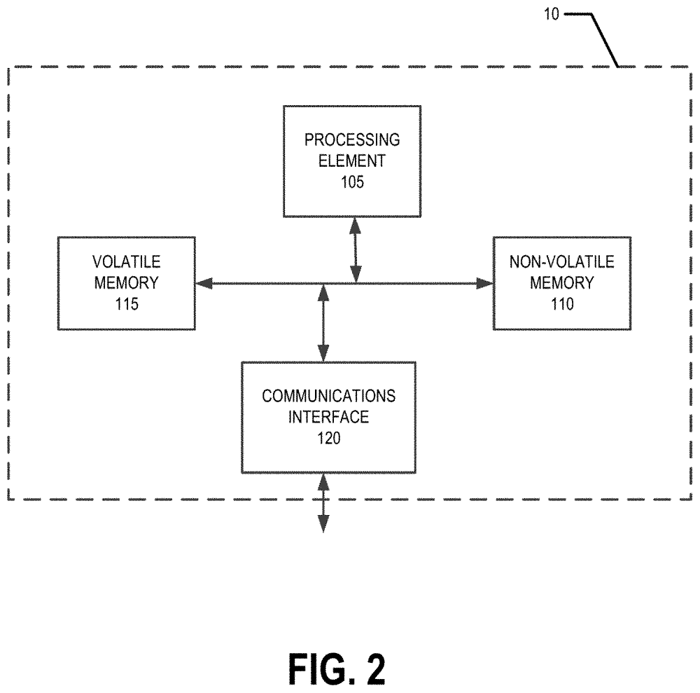

FIG. 2 provides a schematic of a computing platform 10 according to one embodiment of the present invention. In various embodiments, a computing platform 10 may be one or more computing entities storing and/or executing application program code, computer executable instructions, and/or the like to provide a platform for transportation. In general, the terms computing entity, entity, device, system, and/or similar words used herein interchangeably may refer to, for example, one or more computers, computing entities, desktop computers, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the computing platform 10 may include one or more communications interfaces 120 for communicating with various computing entities, such as by communicating data, content, information, and/or similar terms used herein interchangeably that can be transmitted, received, operated on, processed, displayed, stored, and/or the like. For instance, the computing platform 10 may communicate with shipper computing entities 20, carrier computing entities 30, and/or the like.

As shown in FIG. 2, in one embodiment, the computing platform 10 may include or be in communication with one or more processing elements 105 (also referred to as processors, processing circuitry, and/or similar terms used herein interchangeably) that communicate with other elements within the computing platform 10 via a bus, for example. As will be understood, the processing element 105 may be embodied in a number of different ways. For example, the processing element 105 may be embodied as one or more complex programmable logic devices (CPLDs), microprocessors, multi-core processors, coprocessing entities, application-specific instruction-set processors (ASIPs), and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the computing platform 10 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the computing platform 10 may further include or be in communication with volatile media (also referred to as volatile storage, memory, memory storage, memory circuitry and/or similar terms used herein interchangeably). In one embodiment, the volatile storage or memory may also include one or more volatile storage or memory media 115 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 105. Thus, the databases, database instances, database management system entities, data, applications, programs, program modules, scripts, source code, object code, byte code, compiled code, interpreted code, machine code, executable instructions, and/or the like may be used to control certain aspects of the operation of the remote computing entity 50 with the assistance of the processing element 305 and operating system.

As indicated, in one embodiment, the computing platform 10 may also include one or more communications interfaces 120 for communicating with various computing entities, such as by communicating data, content, information, and/or similar terms used herein interchangeably that can be transmitted, received, operated on, processed, displayed, stored, and/or the like. In various embodiments, the communications interface 120 may comprise hardware and/or software components for communicating via one or more networks and/or via one or more communication protocols. In various embodiments, the communications interface includes an antenna, a modem, a circuit board configured to receive and/or process communication signals, and/or the like.

Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the computing platform 10 may be configured to communicate via wireless external communication networks using any of a variety of protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. Although not shown, the computing platform 10 may include or be in communication with one or more input elements, such as a keyboard input, a mouse input, a touch screen/display input, audio input, pointing device input, joystick input, keypad input, and/or the like. The computing platform 10 may also include or be in communication with one or more output elements (not shown), such as audio output, video output, screen/display output, motion output, movement output, and/or the like.

As will be appreciated, one or more of the computing platform's 10 components may be located remotely from other computing platform 10 components, such as in a distributed system. Furthermore, one or more of the components may be combined and additional components performing functions described herein may be included in the computing platform 10. Thus, the computing platform 10 can be adapted to accommodate a variety of needs and circumstances.

### 2. Exemplary Shipper Computing Entity

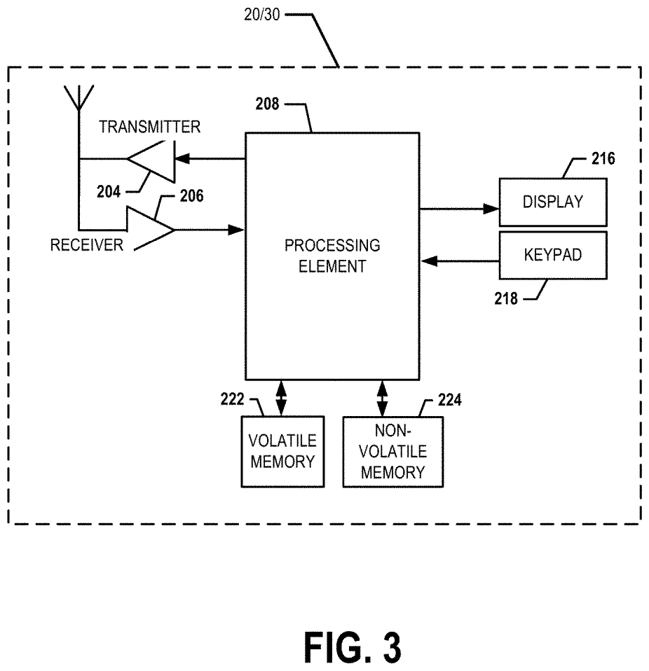

FIG. 2 provides an illustrative schematic representative of a shipper computing entity 20 that can be used in conjunction with embodiments of the present invention. In one embodiment, the shipper computing entities 20 may include one or more components that are functionally similar to those of the computing platform 10 and/or as described below. As will be recognized, a shipper computing entity 20 is operated by a shipper user on behalf of a shipper (e.g., an individual, organization, department of an organization, and/or the like) that is shipping one or more loads of one or more items. As shown in FIG. 3, a shipper computing entity 20 can include an antenna 212, a transmitter 204 (e.g., radio), a receiver 206 (e.g., radio), and a processing element 208 that provides signals to and receives signals from the transmitter 204 and receiver 206, respectively.

The signals provided to and received from the transmitter 204 and the receiver 206, respectively, may include signaling information/data in accordance with an air interface standard of applicable wireless systems to communicate with various entities, such as computing platforms 10, and/or the like. In this regard, the shipper computing entity 20 may be capable of operating with one or more air interface standards, communication protocols, modulation types, and access types. More particularly, the shipper computing entity 20 may operate in accordance with any of a number of wireless communication standards and protocols. In a particular embodiment, the shipper computing entity 20 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. For example, the shipper computing entity 20 is configured to communicate with the computing platform 10 via one or more wired or wireless networks 40.

Via these communication standards and protocols, the shipper computing entity 20 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The shipper computing entity 20 can also download changes, add-ons, and updates, for instance, to its firmware, software (e.g., including executable instructions, applications, program modules), and operating system.

According to one embodiment, the shipper computing entity 20 may include location determining aspects, devices, modules, functionalities, and/or similar words used herein interchangeably. For example, the shipper computing entity 20 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the shipper computing entity's 20 position in connection with a variety of other systems, including cellular towers, Wi-Fi access points, and/or the like. Similarly, the shipper computing entity 20 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The shipper computing entity 20 may also comprise a user interface (that can include a display 216 coupled to a processing element 208) and/or a user input interface (coupled to a processing element 208). For example, the user interface may be an application, browser, user interface, dashboard, webpage, and/or similar words used herein interchangeably executing on and/or accessible via the shipper computing entity 20 to interact with and/or cause display of information. The user input interface can comprise any of a number of devices allowing the shipper computing entity 20 to receive data, such as a keypad 218 (hard or soft), a touch display, voice/speech or motion interfaces, scanners, readers, or other input device. In embodiments including a keypad 218, the keypad 218 can include (or cause display of) the conventional numeric (0-9) and related keys (#, *), and other keys used for operating the shipper computing entity 20 and may include a full set of alphabetic keys or set of keys that may be activated to provide a full set of alphanumeric keys. In addition to providing input, the user input interface can be used, for example, to activate or deactivate certain functions, such as screen savers and/or sleep modes. In various embodiments, the shipper computing entity 20 is configured to provide an IUI via the user interface which a user may interact with via interaction with one or more elements of the user input interface.

The shipper computing entity 20 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the shipper computing entity 20.

### 3. Exemplary Carrier Computing Entity

FIG. 3 provides an illustrative schematic representative of a carrier computing entity 30 that can be used in conjunction with embodiments of the present invention. In one embodiment, the carrier computing entities 30 may include one or more components that are functionally similar to those of the computing platform 10, shipper computing entity 20, and/or as described below. As will be recognized, a carrier computing entity 30 is operated by a carrier user on behalf of a carrier (e.g., an individual, organization, department of an organization, and/or the like) that provides transportation services for transporting loads from corresponding pick-up locations to delivery locations. As shown in FIG. 3, a carrier computing entity 30 can include an antenna 212, a transmitter 204 (e.g., radio), a receiver 206 (e.g., radio), and a processing element 208 that provides signals to and receives signals from the transmitter 204 and receiver 206, respectively.

The signals provided to and received from the transmitter 204 and the receiver 206, respectively, may include signaling information/data in accordance with an air interface standard of applicable wireless systems to communicate with various entities, such as computing platforms 10, and/or the like. In this regard, the carrier computing entity 30 may be capable of operating with one or more air interface standards, communication protocols, modulation types, and access types. More particularly, the carrier computing entity 30 may operate in accordance with any of a number of wireless communication standards and protocols. In a particular embodiment, the carrier computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. For example, the carrier computing entity 30 is configured to communicate with the computing platform 10 via one or more wired or wireless networks 40.

Via these communication standards and protocols, the carrier computing entity 30 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The carrier computing entity 30 can also download changes, add-ons, and updates, for instance, to its firmware, software (e.g., including executable instructions, applications, program modules), and operating system.

According to one embodiment, the carrier computing entity 30 may include location determining aspects, devices, modules, functionalities, and/or similar words used herein interchangeably. For example, the carrier computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the carrier computing entity's 30 position in connection with a variety of other systems, including cellular towers, Wi-Fi access points, and/or the like. Similarly, the carrier computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The carrier computing entity 30 may also comprise a user interface (that can include a display 216 coupled to a processing element 208) and/or a user input interface (coupled to a processing element 208). For example, the user interface may be an application, browser, user interface, dashboard, webpage, and/or similar words used herein interchangeably executing on and/or accessible via the carrier computing entity 30 to interact with and/or cause display of information. The user input interface can comprise any of a number of devices allowing the carrier computing entity 30 to receive data, such as a keypad 218 (hard or soft), a touch display, voice/speech or motion interfaces, scanners, readers, or other input device. In embodiments including a keypad 218, the keypad 218 can include (or cause display of) the conventional numeric (0-9) and related keys (#, *), and other keys used for operating the carrier computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. In various embodiments, the carrier computing entity 30 is configured to provide an IUI via the user interface which a user may interact with via interaction with one or more elements of the user input interface.

The carrier computing entity 30 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the carrier computing entity 30.

### 4. Exemplary Networks

In one embodiment, any two or more of the illustrative components of the architecture of FIG. 1 may be configured to communicate with one another via respective communicative couplings to one or more networks 40. The networks 40 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 40 may have any suitable communication range associated therewith and may include, for example, global networks (e.g., the Internet), MANs, WANs, LANs, or PANs. In addition, the networks 40 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### Exemplary System Operation

According to various embodiments, a computing platform 10 may be configured to provide a platform for transportation services. For example, shipper users associated with one or more shippers and carrier users associated with one or more carriers may interact with one another through the computing platform 10. In a particular embodiment, shipper users may interface with the computing platform 10 via shipper IUIs provided by corresponding shipper computing entities 20, and carrier users may interface with the computing platform 10 via carrier IUIs provided by the corresponding carrier computing entities 30.

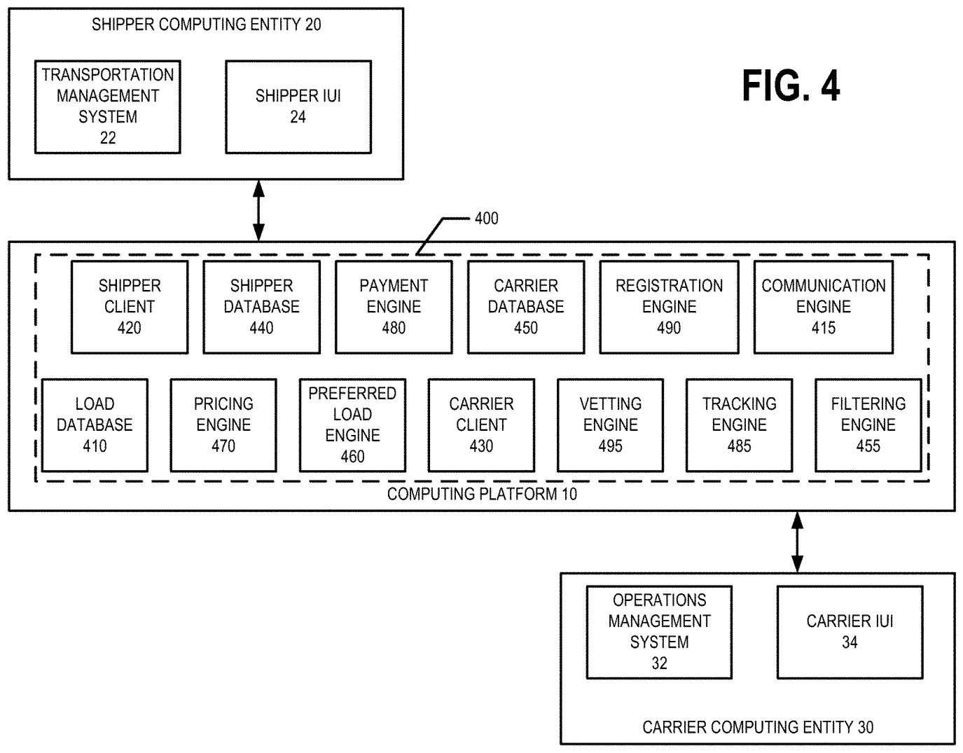

FIG. 4 provides an example software architecture that may be used in an example embodiment to provide the platform 400 for transportation, the shipper IUI 24, and the carrier IUI 31. In various embodiments, a TMS 22 and/or a client thereof is operating on a shipper computing entity 20. In various embodiments, a shipper client 420 operating on the computing platform 10 (and/or the shipper computing entity 20) communicates with the TMS 22 and causes the shipper computing entity 20 to provide the shipper IUI 24. In some embodiments, the shipper client 420 comprises a plug-in configured to plug into the TMS 22. In some embodiments, the shipper client 420 communicates with the TMS 22 via APIs (e.g., by making, receiving, and/or responding to API calls). In some embodiments, an OMS 32 and/or a client thereof is operating on a carrier computing entity 30. In some embodiments, a carrier client 430 operating on the computing platform 10 (and/or the carrier computing entity 30) communicates with the OMS 32 and causes the carrier computing entity 30 to provide the carrier IUI 34. In various embodiments, the carrier client 430 comprises a plug-in configured to plug into the OMS 32. In various embodiments, the carrier client 430 communicates with the OMS 32 via APIs (e.g., by making, receiving, and/or responding to API calls). In an example embodiment, the shipper IUI 24 and/or carrier IUI 34 may provide a shipper/carrier user with the opportunity to initiate a chat (e.g., message-based conversation with a human, chatbot, and/or the like), email, and/or voice call with the other of the shipper/carrier of a particular load.

The computing platform 10 may further comprise and/or be in communication with a shipper database 440 comprising and/or storing shipper profiles for registered shippers (and/or shipper users) and/or a carrier database 450 comprising and/or storing carrier profiles for registered carriers (and/or carrier users). For example, before a shipper user associated with a shipper may submit a load posting, the shipper (e.g., a shipper user associated with the shipper) may register the shipper with the platform 400 to cause a corresponding shipper profile to be generated and stored in the shipper database 440. Similarly, before a carrier user associated with a carrier may book a load for transporting, the carrier (e.g., a carrier user associated with the carrier) may register the carrier with the platform 400 to cause a corresponding carrier profile to be generated and stored in the carrier database 450.

In various embodiments, the computing platform 10 may be in communication with one or more transportation data sources. Examples of transportation data sources include load databases, contract databases, and contact information databases. In various embodiments, the computing platform 10 may comprise and/or be in communication with a load database 410 comprising at least one load record corresponding to each load for which a corresponding load posting has been received by the platform 400. Further, the computing platform 10 may comprise and/or be in communication with a contract database or table (not shown) configured to provide contract information/data (e.g., including contract transportation fee value for transporting loads) that are in force between various shipper-contractor pairs.

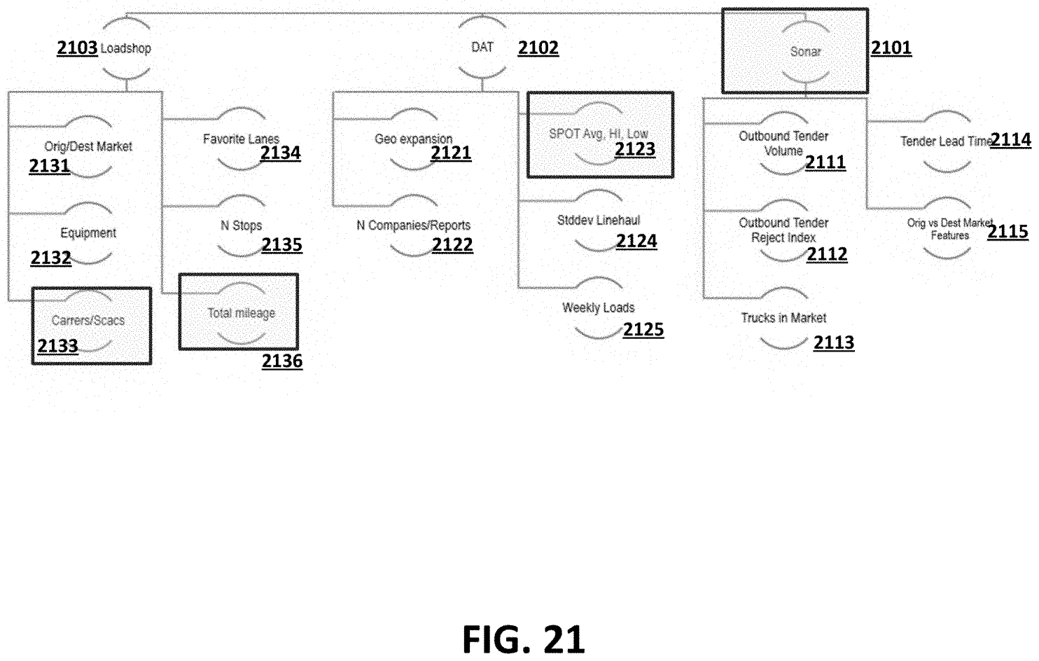

In some embodiments, the transportation data sources include periodically updated data sources and non-periodically updated data sources. Examples of data that may be provided by the noted transportation data sources is depicted in FIG. 21. In particular, the data sources depicted in FIG. 21 include a SONAR data source 2101, a Dial-a-Truck (DAT) data source 2102, and a Loadshop data source 2103.

As depicted in FIG. 21, the SONAR data source 2101 may provide: (i) outbound tender volume values 2111, (ii) outbound tender rejection values 2112, (iii) trucks in the market (TRUK) values 2113, (v) tender lead time values 2114, and (vi) an original-vs.-destination market feature values 2115.

The outbound tender volume values 2111 provided by the SONAR data source 2101 may describe indices of accepted tender volumes on a given day, where each noted index may describe either an inbound tender volume value for a corresponding geographic region or an outbound tender volume for a corresponding geographic region, and further where the geographic regions associated with the outbound tender volume values 2111 include the entire US, regional geographic regions, and market-level geographic regions. For example, if there were 10 national loads accepted on March 1st and 11 national loads accepted on March 2nd, the outbound tender volume value for the entire US (OTVI.USA) may be 1000 on March 1st and 11,000 on March 2nd.

Examples of outbound tender volume values 2111 provided by the SONAR data source 2101 include the weekly average of outbound tender volume indexes (OTVIs) of the entire US market (OTVIWK.USA), the monthly average of the OTVI of the entire US market (OTVIMTH.USA), the quarterly average of the OTVI of the entire US market (OTVIMTH.USA), the percent change in OTVI from 7 days ago (OTVIW/ITVIW), the percent change in OTVI from 14 days ago (OTVIF/ITVIF), the percent change in OTVI from 28 days ago (OTVIM/ITVIM), the percent change in OTVI from 1 year ago (OTVIY/ITVIY), the OTVI for temperature controlled loads (ROTVI), the OTVI for dry van loads (VOTVI), the OTVI for loads moving over 800 miles (LOTVI), the OTVI for loads moving 451-800 miles (TOTVI), the OTVI for loads moving 251-450 miles (MOTVI), the OTVI for loads moving 100-250 miles (SOTVI), the OTVI for loads moving under 100 miles (COTVI), the OTVI for loads moving more than 100 miles (OTVIEX100), and the OTVI for loads moving more than 250 miles (OTVIEX250).

The outbound tender rejection values 2112 provided by the SONAR data source 2101 may describe rejection rates for groups of carriers when loads are tendered to the noted groups of carriers by shippers. Outbound tender rejection values 2112 may be determined by trailer type and length of hall. Outbound tender rejection values may describe carrier behavior in original markets. Examples of outbound tender rejection values 2112 include Van Outbound Tender Rejection (VOTRI), Van Outbound Tender Reject Index—Weekly Change (VOTRIW), Van Outbound Tender Reject Index—Two Week Change (VOTRIF), Van Outbound Tender Reject Index—Monthly Change (VOTRIM), Van Outbound Tender Reject Index—Annual Change (VOTRIY), Reefer Outbound Tender Rejection (ROTRI), Reefer Outbound Tender Reject Index—Weekly Change (ROTRIW), Reefer Outbound Tender Reject Index—Two Week Change (ROTRIF), Reefer Outbound Tender Reject Index—Monthly Change (ROTRIM), Reefer Outbound Tender Reject Index—Annual Change (ROTRIY), Flatbed Outbound Tender Rejection (FOTRI), Flatbed Outbound Tender Reject Index—Weekly Change (FOTRIW), Flatbed Outbound Tender Reject Index—Two Week Change (FOTRIF), Flatbed Outbound Tender Reject Index—Monthly Change (FOTRIM), Flatbed Outbound Tender Reject Index—Annual Change (FOTRIY), City Outbound Tender Rejection (COTRI), Short Haul Outbound Tender Rejection (SOTRI), Mid-haul Outbound Tender Rejection (MOTRI), Tweener Outbound Tender Rejection (TOTRI), and Long-haul Outbound Tender Rejection (LOTRI).

The TRUK values 2113 provided by the SONAR data source 2101 may describe indices of the daily amount of truck activity in different markets with a base period of the first week of April 2018 and a base value of 100. For example, if the TRUK index for Atlanta (TRUK.ATL) has a value of 102 on Sep. 23, 2019, this indicates that on Sep. 23, 2019 the truck activity in Atlanta was two percent higher than the truck activity in Atlanta during the first week of April 28. An example of a TRUK value 2113 is TRUCK.USA that shows a current truck activity in the entire US relative to the truck activity in the entire US on the first week of April 2008. In some embodiments, comparing TRUK values 2113 across geographic regions may provide predictive insights about the ebbs and flows of freight flows as trucks enter and exit markets, thus in turn providing predictive insights about where demand for capacity is surging and supply may be limited.

The tender lead time values 2114 provided by the SONAR data source 2101 may describe daily indices that measure the length of time in days between the load being offered and the requested pickup date. The tender lead time values 2114 may describe shipper behavior patterns. For example, increases in tender lead time values 2114 across time may indicate that shippers in corresponding markets anticipate capacity issues, while decreases in tender lead time values 2114 across time may indicate that shippers in corresponding markets experienced surging values. Examples of tender lead time values include the outbound tender lead time (OTLT) for temperature controlled loads (ROTLT), the OTLT for dry van loads (VOTLT), the OTLT for flatbed loads—national only (FOTLT), the OTLT for international loads (IMOTLT), the OTLT for loads moving over 800 miles (LTOLT), the OTLT for loads moving 451-800 miles (TOTLT), the OTLT for loads moving 251-450 miles (MTOTL), the OTLT for loads moving 100-250 miles (SOTLT), and the OTLT for loads moving under 100 miles (COTLT).

The original-vs.-destination market feature values 2115 provided by the SONAR data source 2101 may describe comparative statistics about features of markets from which particular loads originate and features of markets to which particular loads are headed. Examples of market features described by the original-vs.-destination market feature values 2115 include original-vs.-destination market feature values 2115 that describe market share values, market code values, market name values, outbound volume volatility values, outbound reject volatility values, head-haul volatility values, and tender lead time volatility values.

As further depicted in FIG. 21, the DAT data source 2102 may provide: (i) geographic expansion values 2121, (ii) contributing company/report count values 2122, (iii) spot rate values 2123, (iv) line-haul rate values 2124, and (v) weekly load count values 2125. The geographic expansion values 2121 describe the granularity of geographic areas for which DAT measures are generated. The contributing company/report count values 2122 describe the number of companies and reports that have contributed to each DAT measure. The spot rate values 2123 describe the average spot rate, the highest spot rate, and the lowest spot rate for particular markets. The line-haul rate values 2124 describe the standard deviation of line-haul values for each market. The weekly load count values 2125 describe the number of loads associated with each market during a daily period.

As further depicted in FIG. 21, the Loadshop data source 2103 may provide: (i) original and destination market designator values 2131, (ii) equipment type designator values 2132, (iii) available carrier count values 2133, (iv) favorite lane designation values 2134, (v) stop count values 2135, and (vi) total mileage values 2136. The original and destination market designator values 2131 describe the originating market and the destination market of each load. The equipment type designator values 2132 describe the trailer type (e.g., dry van, reefer, flatbed, and/or the like) needed for each load. The available carrier count value 2133 describes the number of motor carriers (e.g., Standard Carrier Alpha Codes (SCACs)) eligible to book a particular load. The favorite lane designation value 2134 describes the number of favorite line designations associated with a particular load, where the favorite lane designations are designated by carriers, and where a favorite lane designation is associated with a particular load if the particular load can be carried using a particular lane and the particular lane is a designated favorite lane of an available carrier. The stop count values 2135 describe the number of stops on the travel path of a particular load, including the pickup stop and the delivery stop. The total mileage values 2136 describe the number of miles of a travel path associated with a particular load across all of the stops of the noted travel path.

Returning to FIG. 4, in various embodiments, the platform 400 comprises one or more engines. For example, in an example embodiment, the platform 400 comprises a preferred load engine 460. The preferred load engine 460 is configured to identify new loads that satisfy preferred load criteria for one or more carriers, and responsive to identifying a new load that satisfies preferred load criteria for one or more carriers, generate and provide preferred load notifications/indications to the one or more carriers. In various embodiments, the platform 400 further comprises a pricing engine 470. The pricing engine 470 may be configured to automatically determine a dynamic value for transporting a load, select a value for transporting a load to be presented to a carrier user as part of a load posting, and/or the like. In various embodiments, the platform 400 further comprises a payment engine 480 configured to determine when the transportation of a load has reached one or more benchmarks, milestones, and/or thresholds and cause a value corresponding to the same for transportation of that load to be automatically debited from one or more accounts associated with the shipper and automatically credited to one or more accounts associated with the carrier.

In some embodiments, the pricing engine 470 may be configured to generate dynamic values for transportation loads by performing predictive data analysis using a non-persistent input machine learning model. However, while various embodiments of the present invention describe performing predictive data analysis using a non-persistent input machine learning model in relation to generation dynamic values for transportation loads, a person of ordinary skill in the relevant technology will recognize that the predictive data analysis techniques discussed herein can be used to perform any predictive data analysis tasks, including any predictive data analysis tasks performed by the preferred load engine 460, the vetting engine 495, the tracking engine 485, and the filtering engine 455.

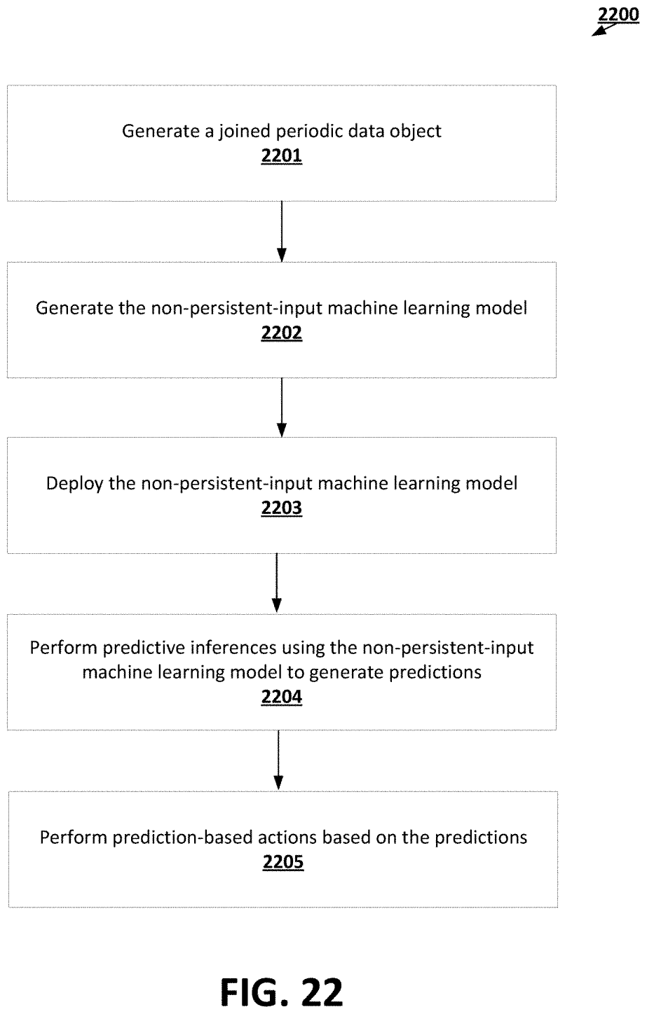

In some embodiments, performing predictive data analysis using a non-persistent machine learning model may be accomplished in accordance with the process 2200 depicted in FIG. 22. Via the various steps/operations of the process 2200, the computing platform 10 can efficiently and effectively generate a non-persistent-input machine learning model, deploy the trained non-persistent input machine learning model, and utilize the deployed non-persistent input machine learning model to perform predictive inferences (e.g., to perform real-time predictive inferences).

The process 2200 begins at step/operation 2201 when the computing platform 10 extracts a joined periodic data object from a group of periodically updated data sources. In some of the noted embodiments, the computing platform 10 periodically retrieves data from the group of periodically updated data sources and performs an aggregate join operation on the retrieved data in order to generate the joined periodic data object.

In some embodiments, a joined periodic data object is a data object that is configured to describe features derived by extracting periodically updated data objects from a group of periodically updated data sources and performing an aggregate join operation across the periodically updated data objects. For example, a joined periodic data object may be generated by extracting market-level feature data associated with various trucking markets from two trucking data sources and performing a market-level aggregate join operation. In the noted example, the joined periodic data object may describe, for each trucking market of the various trucking markets, extracted features that include both the features described by the first trucking database and the features described by the second trucking database, as well as optionally features inferred by performing cross-database inferences across the features described by the first trucking database and the features described by the second trucking database.

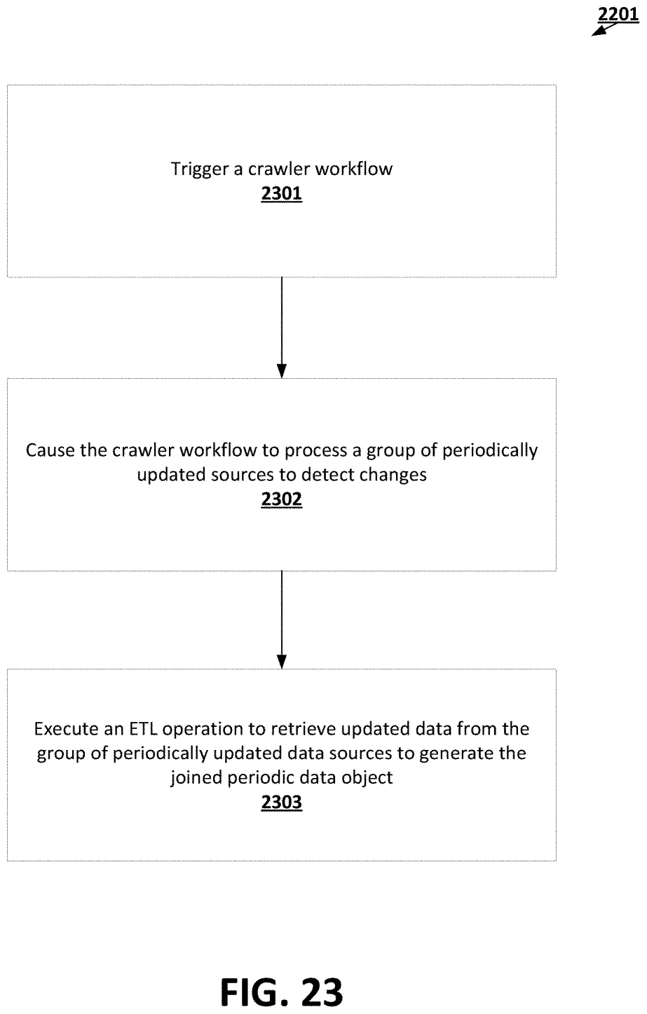

In some embodiments, step/operation 2201 can be performed in accordance with the process depicted in FIG. 23. The process depicted in FIG. 23 begins at step/operation 2301 when the computing platform 10 triggers a crawler workflow at a workflow initiation time that is determined based on an availability time of a group of periodically updated data sources.

A crawler workflow may be a computer-implemented process that is configured to extract data from a group of periodically updated data sources and use the extracted data to generate an extracted data frame that is configured to be stored on a predefined storage medium. An example of a crawler workflow is an AWS Glue Workflow. In some embodiments, the crawler workflow is triggered at a workflow initiation time, where the workflow initiation time describes a predefined time interval associated with triggering the crawler workflow. For example, in some embodiments, the workflow initiation time for a crawler may describe a time period within which the crawler workflow is triggered in order to extract data from the group of data sources. The group of data sources whose corresponding data is extracted by a crawler workflow may include one or more periodically updated data sources and one or more persistently updated data sources. In some embodiments, given a particular crawler workflow that is associated with a group of data sources that include a group of periodically updated data sources, the workflow initiation time for the particular crawler workflow is determined based on the availability time of the group of periodically updated data sources associated with the particular crawler workflow.

As noted above, the group of data sources associated with the crawler workflow may include a group of periodically updated data sources and a group of persistently updated data sources. A periodically updated data source is a computer system that is configured to transmit updated data with a defined periodicity, such that the data transmitted by the periodically updated data source prior to an update time defined by the defined periodicity of the periodically updated data source is deemed outdated. For example, a periodically updated data source may be a data source that provides updated data after a particular time interval during each day, such as after 5 PM each day. Examples of periodically updated data sources include the DAT data servers as well as the SONAR data server provided by FreightWaves. In general, in some embodiments, periodically updated data sources may include external data sources deemed remote/foreign to the computing platform 10, such that the computing platform 10 does not exercise control over data updates provided by the periodically updated data sources. This lack of control in turn requires fine-tuning the data preprocessing and training processes of a non-persistent-input machine learning model to accommodate the non-persistent nature of the availability of the corresponding training data.

In contrast to a periodically updated data source, a persistently updated data source is a computer system configured that is configured to transmit updated data in real-time (i.e., in response to detecting updates in the underlying data). Thus, unlike the data transmitted by a periodically updated data source, the data transmitted by a persistently updated data source is not associated with a defined periodicity, and is therefore deemed to be updated at any time of retrieval. An example of a persistently updated data source is an internal/local data source over which the computing platform 10 exercises control. An example of a persistently updated data source is the Loadshop data source maintained internally by KBX Logistics.

As noted above, the workflow initiation time of the particular crawler workflow is determined based on the availability time of the group of periodically updated data sources. In general, when used in relation to a group of periodically updated data sources, the availability time of the noted group of periodically updated data sources is a time that is deemed to be subsequent to each update time associated with a target period of a periodically updated data source in the group of periodically updated data sources, where the target period of the periodically updated data source may be the earliest period of time whose corresponding updated data has not been extracted by the computing platform 10. For example, given a set of periodically updated data sources that consist of a first periodically updated data source that is updated daily at 12 PM and a second periodically updated data source that is updated daily at 2 PM, the availability time of the given group of periodically updated data sets that is used to determine the workflow initiation time of a crawler workflow associated with the given set of periodically updated data sources may be 3 PM. As another example, given a set of periodically updated data sources that consists of a first periodically updated data source that is updated weekly on Fridays at 1 PM and whose updated data has last been retrieved on Jun. 12, 2020 as well as a second periodically updated data source that is updated daily at 11 PM and whose updated data has last been retrieved on Jun. 18, 2020, the availability time of the given group of periodically updated data sets that is used to determine the workflow initiation time of a crawler workflow associated with the given set of periodically updated data sources may be 12 AM on Jun. 20, 2020.

While various embodiments of the present invention describe extracting data using a single crawler workflow, a person of ordinary skill in the relevant technology will recognize that many crawler workflows may be used. For example, given a set of data sources that include persistently updated data sources PS1, PS2, and PS3, and further given a set of data sources that include periodically updated data sources PD1, PD2, and PD3, the computing platform 10 may identify and trigger two crawler workflows: a first crawler workflow that is associated with the persistently updated data sources PS1, the persistently updated data source PS2, and the periodically updated data source PD3, as well as a second crawler workflow that is associated with the persistently updated data source PS3, the periodically updated data source PD1, and the periodically updated data source PD2. In the noted example, the workflow initiation time of the first crawler workflow may be determined based on the availability time of the periodically updated data source PD3, while the workflow initiation time of the second crawler workflow may be determined based on the availability time that is associated with the group of periodically updated data sources that consists of the periodically updated data source PD1 and the periodically updated data source PD2.

Returning to FIG. 23, at step/operation 2302, the computing platform 10 causes the crawler workflow to process (e.g., scan) the group of periodically updated data sources to detect changes to the group of periodically updated data sources since a prior workflow trigger time in order to update a metadata catalog associated with the group of periodically updated data sources in accordance with the detected changes. In some embodiments, the computing platform 10 causes the crawler workflow to execute a group of data crawling operations, where each data crawling operation in the group of data crawling operations is configured to process data associated with a corresponding periodically updated data source of the group of periodically updated data sources to detect changes to the data associated with the corresponding periodically updated data source since a prior workflow trigger time (e.g., since a prior day). In some of the noted embodiments, to process data associated with a corresponding periodically updated data source of the group of data sources detect changes to the noted data, a data crawling operation is configured to identify an address of the corresponding periodically updated data source, access the identified address to access the target data, run classifiers to infer the schema of the data, create an inferred schema for the data, and write metadata associated with the inferred schema to the metadata catalog.

A metadata catalog may be a data object that includes references to data extracted using a crawler workflow as well as an inferred schema of the data as determined by the crawler workflow. An example of a metadata catalog is the AWS Glue Data Catalog that includes metadata tables, where the metadata tables include, for each extracted data file of a group of extracted data files, a reference to the extracted data file on an internally managed data store, an inferred metadata of the extracted data file, and an inferred classification of the extracted file, where the inferred metadata of an extracted data file and the inferred classification of an extracted data file may be determined using an AWS Glue Workflow. In some embodiments, a metadata catalog may be used to access previously extracted data associated with a group of data sources in order to compare the previously extracted data and recently extracted data associated with the group of data sources. In some of the noted embodiments, in response to determining changes between the previously extracted data and recently extracted data associated with the group of data sources, the metadata catalog may be updated to reflect updated references to the updated data and/or to reflect updated metadata for the updated data.

At step/operation 2303, the computing platform 10 causes the crawler workflow to execute an extract-transform-load (ETL) operation to retrieve updated data from the group of periodically updated data sources based on the updated metadata catalog. In some embodiments, the ETL operation is configured to create an entry gate application (e.g., a SparkContext object) in order to connect to an execution cluster (e.g., a Spark cluster), identify a configuration file which includes the transformation logic used by a cluster-based data retrieval operation (e.g., a PySpark job) to retrieve target data, and cause the cluster-based data retrieval operation to execute the transformation logic in order to retrieve the data from the group of data sources. In some embodiments, the computing platform 10 scans the target path associated with the joined periodic data object and refreshes the metadata catalog, which can later be used to perform ad-hoc queries on the stored data.

In some embodiments, subsequent to retrieving the target data from the group of data sources, the computing platform 10 is configured to perform an aggregate join operation across the data retrieved from the group of periodically updated data sources in order to generate a joined periodic data object. The aggregate join operation may be a computer-implemented process that is configured to join data entries described by two or more input data objects (e.g., a data object containing data extracted from a first periodically updated data source and a data object containing data extracted from a second periodically updated data source) across common data associations. For example, the aggregate join operation performed on a first data object containing SONAR data and a second data object containing DAT data may merge data entries from the two data objects that correspond to common markets/geographical regions, thus creating a resultant merged joined data object that describes both SONAR-based features and DAT-based features for a particular market/geographical region. In some embodiments, subsequent to generating the joined periodic data object, the computing platform 10 is configured to generate a final data-frame that describes the joined periodic data object.

Returning to FIG. 22, at step/operation 2202, the computing platform 10 generates a trained non-persistent-input machine learning model based on the joined periodic data object. In some embodiments, the computing platform 10 combines the joined periodic data object and persistently updated data associated with a group of persistently updated data sources as training data used to train the non-persistent-input machine learning model.

In some embodiments, a non-persistent-input machine learning model is a machine learning model that is configured to be trained using training data derived based at least in part using data extracted from at least one periodically updated data source. Because of the non-persistent nature of the input training data for the noted non-persistent-input machine learning models, training such non-persistent-input machine learning models presents unique challenges in terms of both appropriately adjusting the timing of retrieval of periodically updated as well as setting the temporality of the persistently updated data in order to provide temporal compatibility across the periodically updated data and persistently updated data. An example of a non-persistent-input machine learning model is a machine learning model that is configured to generate an optimal price for a proposed load based on joined periodic data generated using SONAR data and DAT data as well as using persistently updated Loadshop data.

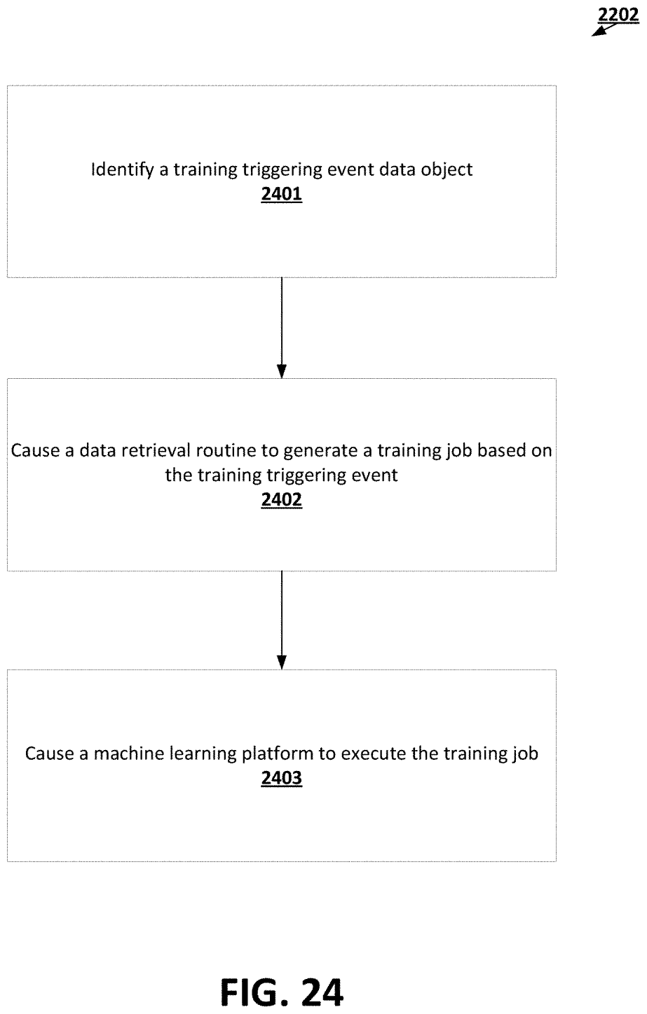

In some embodiments, step/operation 2202 may be performed in accordance with the process depicted in FIG. 24. The process depicted in FIG. 24 begins at step/operation 2401 when the computing platform 10 identifies a training triggering event that is caused by executing operations associated with a training event detection data object, where the training triggering event describes a training configuration file and a persistent data time window for the persistently updated data associated with the group of persistently updated data sources. For example, the computing platform 10 may identify a triggering event caused by operations specified in a trigger data field of a JavaScript Object Notation (JSON) file that is configured to generate a training triggering event upon detecting changes to the joined periodic data object.

A training event detection data object may be a data object that includes operations that, when executed, cause detecting any qualified changes to a joined periodic data object and generating a training triggering event in response to detecting at least one qualified change to the joined periodic data object. In some embodiments, the triggering event detection data object is configured to generate a training triggering event in response to detecting any changes to a joined period data object. In some embodiments, the triggering event detection data object is configured to generate a training triggering event in response to detecting predefined changes to a joined periodic data object, such as changes to particular data fields of the joined periodic data object, changes to the schema of the joined periodic data object, and/or changes to the data storage metadata associated with the joined periodic data object.

A training triggering event may describe a recommendation for training a non-persistent-input machine learning model in accordance with the training configuration data associated with a training configuration data object that is referenced by the training triggering event as well as a persistent data time window described by the training triggering event. As noted above, a training triggering event may be generated by executing operations defined by a training event detection data object, where the noted operations define qualified changes to a joined periodic data object that cause a need for retraining the non-persistent-input machine learning model. In some embodiments, the training configuration data described by a training triggering event describe at least one parameter, at least hyper-parameter, and/or at least one operation of a training process configured to generate the non-persistent-input machine learning model based on training data that includes a joined periodic data object as well as data extracted from a group of persistently updated data sources.

As described above, a training triggering event may further describe the persistent data time window. In some embodiments, the persistent data time window associated with a triggering training event may describe a range of timestamps associated with persistently updated data entries extracted from a group of persistently updated data sources that are deemed related to a training event that is recommended by the training triggering event. For example, a particular training triggering event may describe that only persistently updated data having timestamps up to a certain point in time are deemed related to a corresponding training event, where the certain point in time is defined by the persistent data time window. In some embodiments, the persistent data time window is determined based, at least in part, on the availability time of the group of periodically updated data sources used to generate the joined periodic data object. For example, in some embodiments, the upper bound of the persistent data time window is the availability time. As another example, in some embodiments, the upper bound of the persistent data time window is the endpoint of a latency period following the availability time.

At step/operation 2402, the computing platform 10 causes a data retrieval routine to generate a training job based on the training triggering event. In some embodiments, the computing platform 10 is configured to first cause the data retrieval routine to extract persistently updated data from the group of persistently updated data sources in accordance with the persistent data time window. Afterward, the computing platform 10 is configured to generate a training job based on the joined periodic data object, retrieved persistently updated data, and training configuration parameters defined by the training configuration data object which was described by the training triggering event.

In some embodiments, the data retrieval routine is a lambda function. In some of the noted embodiments, the computing platform 10 invokes the lambda function and passes the metadata derived from the training triggering event, including the training configuration data object described by the training triggering event and the persistent data time window described by the training triggering event, to the lambda function as parameters of the lambda function. In some of the noted embodiments, the lambda function is configured to retrieve the persistently updated data in accordance with the persistent data time window and to generate a training job based on the joined periodic data object, retrieved persistently updated data, and training configuration parameters defined by the training configuration data object which was described by the training triggering event.

At step/operation 2403, the computing platform 10 causes a machine learning platform to generate the non-persistent-input machine learning model by performing the training job. In some embodiments, the machine learning platform executes the training job in a Docker container in accordance with the training configuration data associated with the training job and the model definition data associated with the training job. An example of the machine learning platform is the Amazon SageMaker platform. In some embodiments, subsequent to generating the non-persistent-input machine learning model, the machine learning platform stores generated parameters of the model to a compressed file that is stored on an internally managed storage medium.

Returning to FIG. 22, at step/operation 2203, the computing platform 10 deploys the non-persistent-input machine learning model to a machine learning framework in order to generate a deployed model. In some embodiments, upon successful training of the non-persistent-input machine learning model, the computing platform 10 generates a model deployment routine that is configured to create a trained model object for the trained the non-persistent-input machine learning model as well as an end-point configuration data object for the trained model data object.

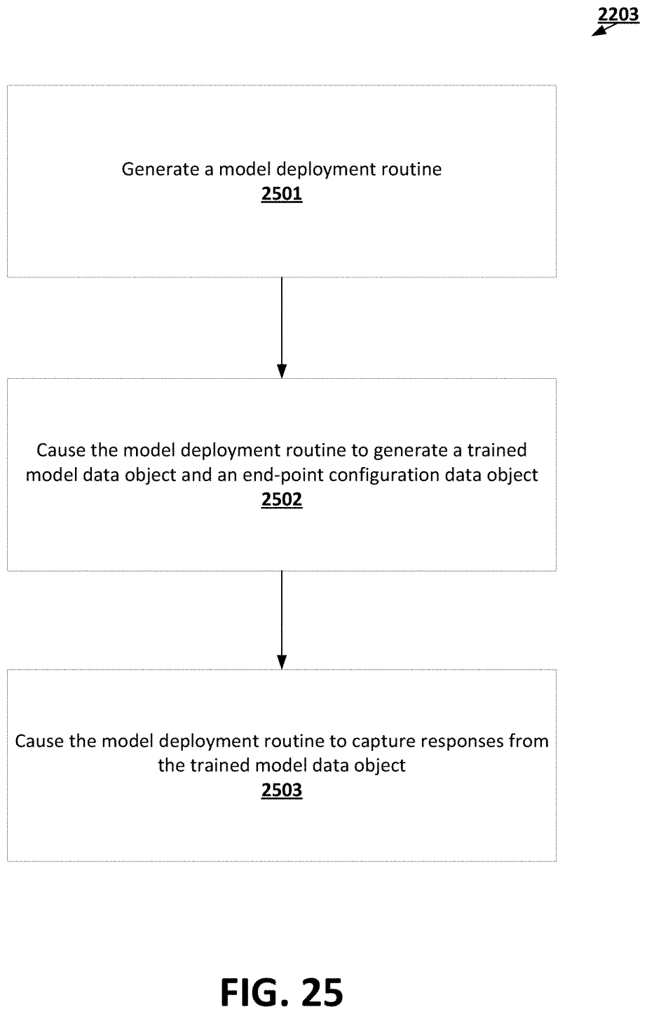

In some embodiments, step/operations 2203 can be performed in accordance with the process depicted in FIG. 25. The process depicted in FIG. 25 begins at step/operation 2501 when the computing platform 10 generates a model deployment routine (e.g., a lambda function). In some embodiments, upon successful training of the non-persistent-input machine learning model, the computing platform 10 stores the trained non-persistent-input machine learning model in a designated location of an internally managed storage medium. Afterward, the internally managed storage medium generates an event that is configured to generate a lambda function, where the parameters of the lambda function may include metadata of the stored non-persistent-input machine learning model as stored in the internally managed storage medium and model configuration data.

At step/operation 2502, the computing platform 10 causes the model deployment routine to generate a trained model data object as well as an end-point configuration data object for the trained model data object. An example of a trained model data object is an Amazon SageMaker model data object. In some embodiments, the trained model data object is associated with an end-point configuration data object that provides an end-point for using the trained model data object to perform predictive inferences. For example, the end-point configuration data object may provide an application programming interface (API) end-point for using the trained model data object to perform various predictive inferences (e.g., to perform real-time predictive inferences).

At step/operation 2503, the computing platform 10 causes the model deployment routine to capture responses from the trained model data object. In some embodiments, the computing platform 10 causes the lambda function to capture responses from the Amazon SageMaker model data object during end-point configuration. In some of the noted embodiments, the computing platform 10 causes the Amazon SageMaker model data object to transmit the captured responses to a Log Group in CloudWatch.

Returning to FIG. 22, at step/operation 2204, the computing platform 10 performs predictive inferences using the deployed model in order to generate predictions. In some embodiments, to perform the predictive inferences, the computing platform 10 generates a predictive inference routine (e.g., a lambda function) that is configured to access an end-point configuration data object for the deployed model data object and uses the predictive inference routine to perform the predictive inferences.

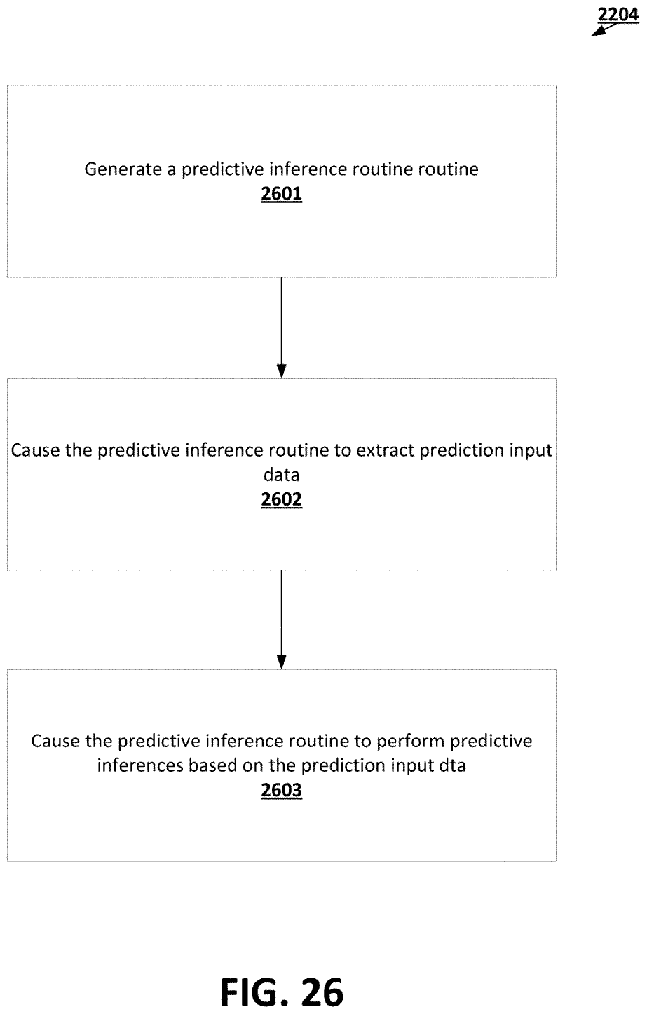

In some embodiments, step/operation 2204 may be performed in accordance with the process depicted in FIG. 26. The process depicted in FIG. 26 begins at step/operation 2601 when the computing platform 10 generates a predictive inference routine. In some embodiments, the computing platform 10 constructs a signed request with new or updated transactions and sends it to an API gateway endpoint. The API gateway endpoint may validate the signature on the request to authenticate the user and then check its resource policy to confirm whether this user should have access. If the user is authorized, the request is forwarded to a Lambda function that serves as an integration point with the end-point configuration data object (e.g., an Amazon SageMaker endpoint data object).

At step/operation 2602, the computing platform 10 causes the predictive inference routine to extract input data. In some embodiments, the predictive inference routine causes the end-point configuration data object to extract input data and load preprocessed periodically updated data (e.g., preprocessed DAT/SONAR data) from a particular daily partition, which will be used to join with persistently updated data (e.g., Loadshop data). Logs from the container operated by SageMaker may also be continuously fed to a CloudWatch Log Group for later reference. These logs may include checkpoints from data transformations.

At step/operation 2603, the computing platform 10 causes the predictive inference routine to perform the predictive inferences. In some embodiments, the computing platform 10 causes the end-point configuration data object to perform necessary data transformations on the input data, feed the transformed data to the model, generate predictions based on the transformed data, and return the predictions them to the Lambda function. Lambda function may then parse the results, convert them to JSON format, and return the results back to the API gateway channel that invoked it. The API Gateway may further return the results back to the caller via it's endpoint.

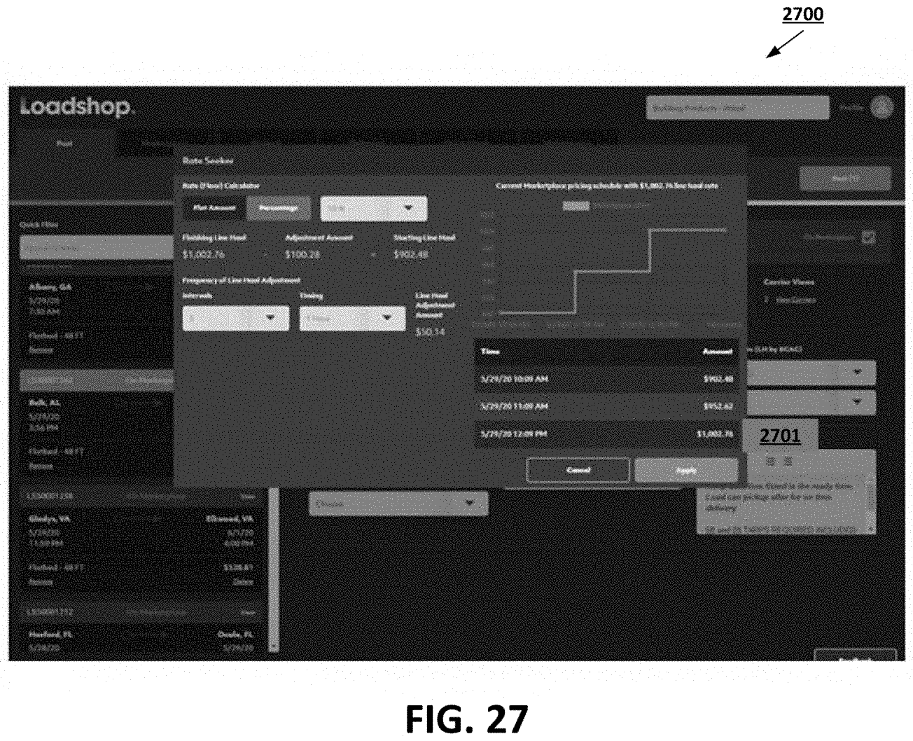

Returning to FIG. 22, at step/operation 2205, the computing platform 10 performs one or more prediction-based actions based on the predictions. Examples of prediction-based actions include displaying a user interface that describes the predictions, performing one or more operational load balancing operations based on the predictions, generating one or more electronic notification data objects based on the predictions, and/or the like. In some embodiments, the predictions include an optimal price for a particular trucking load. In some of the noted embodiments, performing the one or more prediction-based actions includes displaying the optimal FIG. using a prediction output user interface, such as the prediction output user interface 2700 of FIG. 27 that is configured to display the optimal price 2701 for a particular load.

In various embodiments, the platform 400 may further comprise one or more of a registration engine 490, a vetting engine 495, a filtering engine 455, a communication engine 415, a tracking/visibility engine 485, and/or the like. In various embodiments, a registration engine 490 may be configured to guide a carrier user and/or shipper user through a registration process and cause a corresponding carrier profile and/or shipper profile to be generated and stored in the appropriate database (e.g., carrier database 450 and/or shipper database 440), allow a carrier user and/or shipper user to update a carrier profile or shipper profile corresponding to an associated carrier or shipper, and/or otherwise manage carrier profiles and/or shipper profiles. In various embodiments, a vetting engine 495 may be configured to perform one or more vetting operations for carriers and/or shippers as part of the registration process and/or as part of a periodic vetting process, determine if feedback regarding a carrier or shipper indicates that a carrier or shipper should be removed from the platform and/or investigated for misconduct, and/or the like. In various embodiments, the vetting engine 495 may determine the credit worthiness of shippers and/or a dependability of carriers, such that carriers and shippers are ensured to engage in dealings with legitimate and trustworthy business entities via the platform. In various embodiments, a filtering engine 455 is configured to, for example, receive a query from a carrier computing entity 30 (e.g., provided via user interaction with a carrier IUI 34) associated with a carrier, access and search the load database 410 to identify load postings that satisfy the query (and which may be provided to the carrier), and return the identified load postings to be provided to the carrier computing entity 30. A communication engine 415 may be configured to aid in communication between a shipper and a carrier regarding a load that the shipper is shipping and the carrier is transporting. For example, the communication engine 415 may provide chat or other message-based functions or voice call functions to facilitate communication between the shipper and the carrier regarding the load being shipped by the shipper and transported by the carrier. For instance, the communication engine 415 may be configured to facilitate direct communication between the shipper and the carrier through the computing platform 10. In various embodiments, a tracking/visibility engine 485 is configured to receive location information/data (e.g., actual scans, virtual scans, GPS location information/data, movement information/data) regarding a load that is being transported and interpret, store, and provide transportation progress information/data to an associated shipper and/or carrier. As will be recognized, one or more of such engines and/or other engines may be implemented as one or more program modules, computer executable code portions, and/or the like.

### 1. Carrier/Shipper Registration

In an example embodiment, as indicated, before a carrier user or shipper user may access and/or utilize various features of the platform, the associated carrier or shipper may be required to register. For example, a carrier user and/or shipper user (e.g., operating a carrier computing entity 30 or shipper computing entity 20) may provide profile information/data. For example, a carrier user and/or shipper user may use the keypad 218 and/or other input device of the carrier computing entity 30 or shipper computing entity 20 to provide user input to enter and/or select profile information/data corresponding to the associated carrier or shipper. In various embodiments, the carrier computing entity 30 or shipper computing entity 20 may provide (e.g., transmit) the entered and/or selected profile information/data to the computing platform 10. In various embodiments, registration of the carrier and/or shipper causes a corresponding carrier profile and/or shipper profile to be generated and stored in a corresponding data store (e.g., carrier database 450 or shipper database 440). In various embodiments, the registration process may include automatically vetting the shipper and/or carrier to ensure that the shipper and/or carrier are legitimate business entities.

As will be recognized, a shipper user may operate a shipper computing entity 20 to access a registration IUI. For instance, the shipper computing entity 20 (e.g., using processing element 208) may execute application program code, computer executable code, and/or the like to provide a registration IUI through the shipper IUI 24. For example, the shipper client 420 may cause the shipper IUI 24 to provide a registration IUI via a user interface of the shipper computing entity 20. In various embodiments, the shipper IUI 24 may be a dedicated application, a dashboard, a portal, and/or the like accessed via a browser (e.g., a web browser), an app, and/or the like. The registration IUI may comprise a number of fields and/or selectable elements that the shipper user may interact with (e.g., via the user input interface(s) of the shipper computing entity 20) to insert, provide, and/or select shipper profile information/data corresponding to the shipper associated with the shipper user. For instance, the shipper profile information/data may include identifying information/data and/or contact information/data such as a shipper name, a shipper mailing address, shipper telephone number, instant message address, shipper email address, and/or other information/data that may be used to identify and/or contact the shipper. In various embodiments, the shipper profile information/data may further include information/data identifying a shipper account that may be automatically debited to pay for the transportation of loads. In various embodiments, the shipper profile information/data may further include preferences information/data. For example, the preferences information/data may indicate one or more preferred carriers, a shipper-defined set of preferred carriers, or that only carriers with a specified minimum rating are allowed to view load postings or book loads shipped by the shipper. The preferences information/data may include payment preferences, shipper-carrier contract information/data for contracts associated with the shipper, and/or the like. In various embodiments, after the shipper user has entered, provided, and/or selected the shipper profile information/data, the shipper profile information/data is provided to the computing platform 10 and stored in the shipper database 440. For instance, if a shipper profile does not yet exist for the shipper in the shipper database 440, a new shipper profile may be generated based on the shipper user entered, provided, and/or selected shipper profile information/data. Then, the generated shipper profile may be stored in the shipper database 440. If a shipper profile does already exist in the shipper database 440, the existing shipper profile may be updated based on the shipper user entered, provided, and/or selected shipper profile information/data.

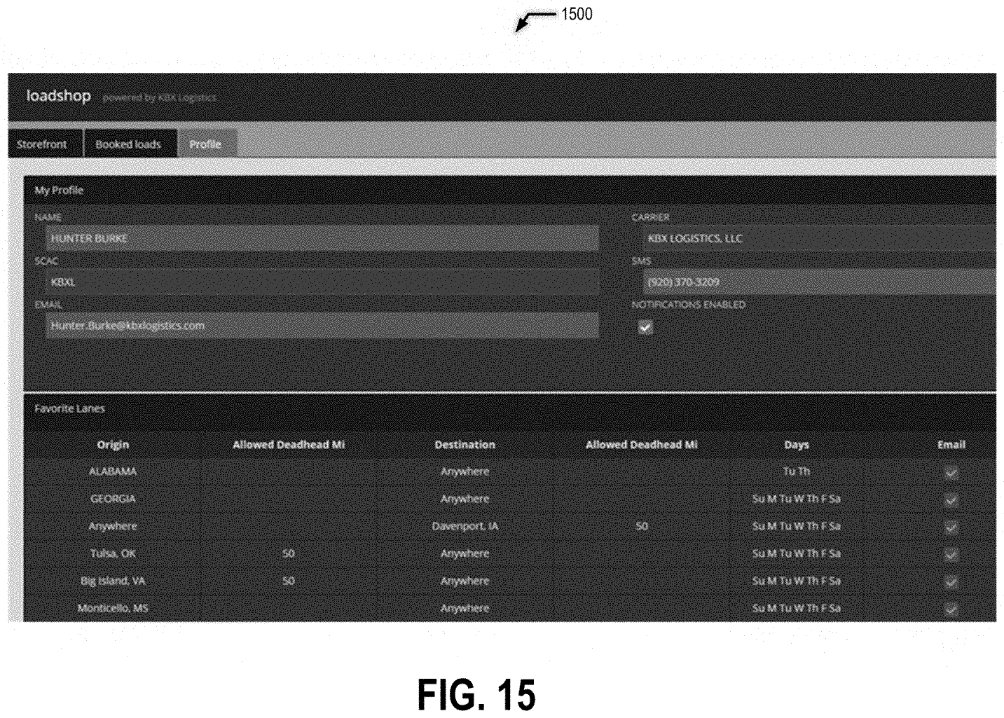

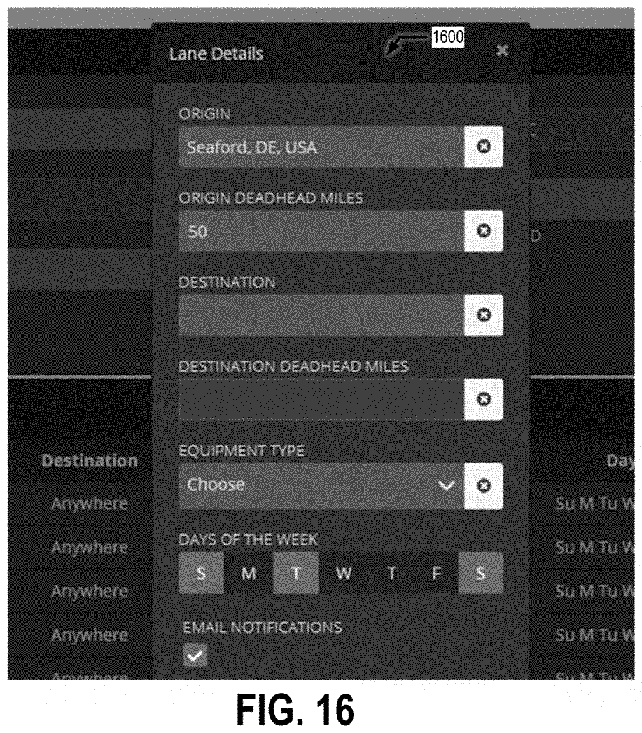

In various embodiments, a carrier user may operate a carrier computing entity 30 to access a registration IUI. For example, the carrier computing entity 30 (e.g., using processing element 208) may execute application program code, computer executable code, and/or the like to provide a registration IUI through the carrier IUI 34. For instance, the carrier client 430 may cause the carrier IUI 34 to provide a registration IUI via a user interface of the carrier computing entity 30. In various embodiments, the carrier IUI 34 may be a dedicated application, a dashboard, a portal, and/or the like accessed via a browser (e.g., a web browser), an app, and/or the like. The registration IUI may comprise a number of fields and/or selectable elements that the carrier user may interact with (e.g., via the user input interface(s) of the carrier computing entity 30) to insert, provide, and/or select carrier profile information/data corresponding to the carrier associated with the carrier user. For example, the carrier profile information/data may include identifying information/data and/or contact information/data such as a carrier name, a carrier mailing address, carrier telephone number, carrier email address, and/or other information/data that may be used to identify the carrier and contact the carrier. In various embodiments, the carrier profile information/data may further include information/data identifying a carrier account that may be automatically credited with payment for the transportation of loads. In various embodiments, the carrier profile information/data may further include preferences information/data. For instance, the preferences information/data may indicate preferred load criteria (e.g., load types, lanes, and/or the like) used by the preferred load engine 460 to identify preferred loads for the carrier, used by a complementary load engine to identify complementary loads for the carrier, and/or the like. The preferences information/data may include payment preferences, shipper-carrier contract information/data for contracts associated with the carrier, one or more home bases for the carrier (and/or drivers that work for the carrier), and/or the like. In various embodiments, the preferred load criteria and/or complementary load criteria may be received via user input (e.g., via the carrier IUI 34) or learned (e.g., using machine learning) through monitoring carrier behavior (e.g., loads booked, and/or the like) and/or a combination thereof. In various embodiments, after the carrier user has entered, provided, and/or selected the carrier profile information/data, the carrier profile information/data is provided to the computing platform 10 and stored in the carrier database 450. For example, if a carrier profile does not yet exist for the shipper in the carrier database 450, a new carrier profile may be generated based on the carrier user entered, provided, and/or selected carrier profile information/data and the generated carrier profile may be stored in the carrier database 450. If a carrier profile does already exist in the carrier database 450, the existing carrier profile may be updated based on the carrier user entered, provided, and/or selected carrier profile information/data. For instance, FIG. 15 shows an example carrier registration/profile update view 1500 of a carrier IUI 34 via which a carrier user may update a carrier profile. FIG. 16 shows an example preferred load set up view 1600 of the carrier IUI 34 that a carrier user may use to define preferred load criteria.

### 2. Exemplary Operations of a Computing Platform

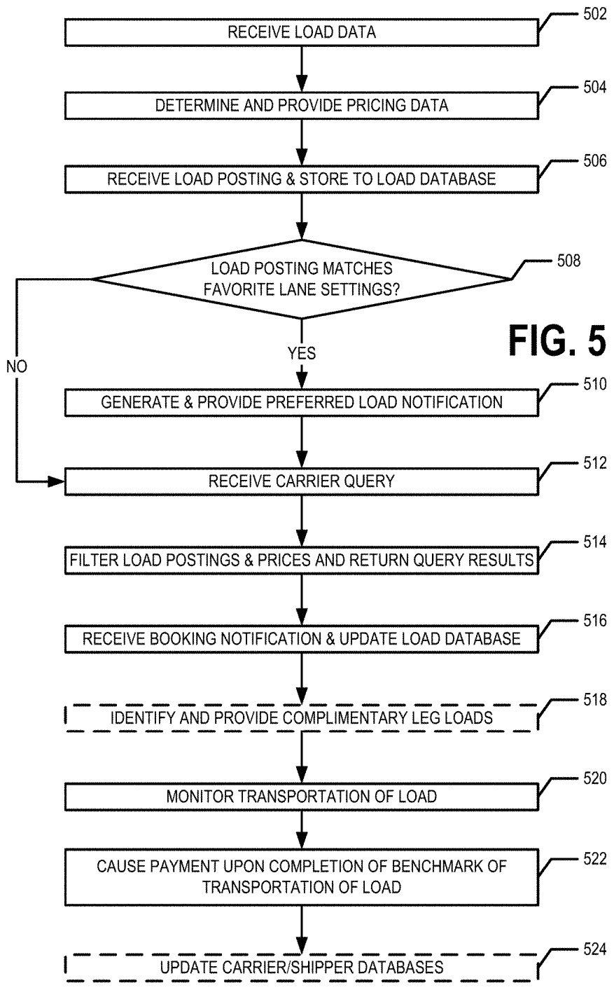

In various embodiments, the computing platform 10 is configured to cause a shipper computing entity 20 to provide a shipper IUI 24 via a user interface of the shipper computing entity 20. In various embodiments, the shipper IUI 24 may be an IUI through which a shipper user interacts with the TMS 22. In an example embodiment, the shipper IUI 24 and/or the shipper client 420 are configured to interact with the TMS 22 (e.g., as a plug-in, via one or more APIs, and/or the like). In various embodiments, a shipper user operating the shipper computing entity 20 interacts with the shipper IUI 24 to cause the shipper computing entity 20 to submit one or more load postings. The computing platform 10 is configured to receive load postings, store the load postings in the load database 410, automatically identify preferred loads for carriers (based on preferences and/or machine learning) and provide corresponding notifications, provide access to load postings to carrier users (e.g., via the carrier IUI 34 operating on respective carrier computing entities 30) with appropriate transportation fee values, receive load bookings, and/or cause debiting of payment for transportation of the load from the shipper account and crediting of payment for transportation of the load to the carrier account. FIG. 5 provides a flowchart of various processes, procedures, operations, and/or the like performed by the computing platform 10 to provide the integrated platform for load transportation.

Starting a step/operation 502, load information/data corresponding to a new load posting is received. For example, the computing platform 10 receives load information/data corresponding to a new load posting by, for instance, a shipper user operating a shipper computing entity 20 to provide and/or select load information/data. The load information/data may be provided by the shipper computing entity 20 such that the computing platform 10 receives the load information/data corresponding to the new load posting. For example, the load information/data may indicate a pick-up location, pick-up time/window, delivery location, delivery time/window, special handling instructions, information/data regarding the equipment required/desired for transporting the load, and/or the like. In an example embodiment, the pick-up location may be a street address, geolocation, landmark, and/or any other identifiable location at which the load is to be picked up from by the carrier. In an example embodiment, the pick-up time/window is a date and time and/or a period of time during one or more dates during which the carrier is to pick up the load from the pick-up location. In an example embodiment, the delivery location may be a street address, geolocation, landmark, and/or any other identifiable location at which the load is to be delivered to by the carrier. In an example embodiment, the delivery time/window is a date and time and/or a period of time during one or more dates during which the carrier is to deliver the load to the delivery location.

At step/operation 504, based on the received load information/data, pricing information/data may be programmatically determined and provided. For instance, the computing platform 10 (e.g., via the pricing engine 470) may determine pricing information/data corresponding to the load information/data, such as the pick-up location, pick-up time/window, delivery location, delivery time/window, special handling instructions, information/data regarding the equipment required/desired for transporting the load, and/or the like. For example, the pricing information/data may take into account the distance between the pick-up location and the delivery location, the amount of time between the pick-up time/window and the delivery time/window, volume of load postings that have an overlapping transportation period, an expected volume of load postings with overlapping transportation periods (e.g., determined based on an analysis of historical load information/data such as that stored in the load database 410, for example), one or more historical loads (e.g., already been transported loads) that have an overlapping transportation period (e.g., overlapping days of the calendar even if the historical load was transported in a different year), volume of load postings that have an overlapping transportation path, an expected volume of load postings with overlapping transportation paths (e.g., determined based on an analysis of historical load information/data such as that stored in the load database 410, for example), and/or the like. A transportation period for a load is the time period between the pick-up time/window and the delivery time/window. In various embodiments, the transportation path of a load posting is a shortest distance, a shortest travel time, and/or other route from the pick-up location of the load posting to the delivery location of the load posting. In various embodiments, the pricing information/data may comprise a suggested transportation fee value, a distance-based transportation fee (e.g., determined based on the length of the transportation path), and/or the like. The pricing information/data may be provided such that the shipper computing entity 20 receives the pricing information/data and provides at least a portion of the pricing information/data via the shipper IUI 24.

At step/operation 506, a load posting is received. For instance, the computing platform 10 may receive a load posting information/data object comprising load information/data, a transportation fee value, and/or the like for the load. For example, the shipper user operating the shipper computing entity 20 may provide and/or select a transportation fee value for transporting the load (e.g., based on the pricing information/data) and/or select a dynamic pricing option. The shipper computing entity 20 may then provide the load posting such that the computing platform 10 receives the load posting. The computing platform 10 may then store the load posting in the load database 410 (e.g., in memory 110, 115). In various embodiments, the load posting comprises the shipper, pick-up location, pick-up time/window, delivery location, delivery time/window, special handling instructions, information/data regarding the equipment required/desired for transporting the load, and/or the like for the load. In various embodiments, the load posting comprises a transportation fee value. In various embodiments, a portion of the transportation fee value may be a flat transportation fee (e.g., independent of the distance that the load is being transported) and a portion of the transportation fee value may be determined based on the distance the load is being transported. In an example embodiment, when a load posting is received, a load identifier is assigned to the load posting (and/or the corresponding load) and the load identifier is stored as part of the load posting. In various embodiments, the load identifier is configured to uniquely identify the load posting and/or the corresponding load within the platform.

At step/operation 508, it is determined if the load posting satisfies the preferred load criteria of one or more carriers. For instance, the computing platform 10 (e.g., via the preferred load engine 460) may determine if the load posting satisfies the preferred load criteria of one or more carriers. This may be performed in real-time or in batch (every 10, 50, or 100 loads). For example, the preferred load criteria for a carrier may include a preferred pick-up area (e.g., within a hundred miles of an address, landmark, city, and/or the like), a preferred delivery area (e.g., within a hundred miles of an address, landmark, city, and/or the like), the pick-up and/or delivery time/window is on a particular day of the week and/or a particular time of day, a minimum transportation fee value, and/or the like and/or various combinations thereof. In an alternative embodiment, the preferred load criteria may be learned (e.g., using machine learning) based on historical loads.

When, at step/operation 508, it is determined that the load posting satisfies the preferred load criteria for one or more carriers, a preferred load notification/indication is automatically generated and provided, at step/operation 510. For instance, responsive to determining that the load posting satisfies the preferred load criteria for one or more carriers, the computing platform 10 may generate and provide one or more preferred load notifications/indications. For example, the preferred load notification/indication may be an email, text message, app notification, alert, and/or other communication provided to an electronic destination address indicated in the carrier profile. In an example embodiment, the preferred load notification/indication may comprise a link and/or the like for accessing the load posting (e.g., via the carrier IUI 34).

At step/operation 512, a carrier query is received. For instance, the computing platform 10 may receive a carrier query comprising one or more query criteria originating from a carrier user operating a carrier computing entity 30. For instance, the query criteria may include a pick-up area (e.g., within a hundred miles of an address, landmark, city, and/or the like), a delivery area (e.g., within a hundred miles of an address, landmark, city, and/or the like), a pick-up and/or delivery time/window, a minimum transportation fee value, and/or the like and/or various combinations thereof.

At step/operation 514, the computing platform 10 (e.g., via the filtering engine 455) may identify one or more load postings that satisfy the query criteria provided by the carrier query. In various embodiments, the identified one or more load postings are filtered to only include load postings that the carrier (e.g., carrier users associated with the carrier) is allowed to access. For example, if a load posting and/or the shipper profile of the associated shipper indicates that a load posting for a load shipped by the shipper should only be viewed by a first set of carriers, the load posting will be filtered out of the identified one or more load postings unless the carrier associated with the carrier query is included in the first set of carriers.

In an example embodiment, the identified one or more load postings may be filtered to only include load postings having a transportation fee value that is equal to or greater than a contract transportation fee value contracted between the shipper associated with the load posting and the carrier that submitted the carrier query. For instance, if Shipper A and Carrier B have a contract setting the contract transportation fee value at $800, a first load posting associated with Shipper A and having a transportation fee value of $700 will be filtered out of the identified one or more load postings identified in response to Carrier B's carrier query. However, a second load posting having a transportation fee value of $800 and a third load posting having a transportation fee value of $1000 will not be filtered out of the identified one or more load postings identified in response to Carrier B's carrier query. In various embodiments, the computing platform 10 (e.g., via the filtering engine 455) will determine which transportation fee value to provide with the load posting when the load posting is provided to the carrier computing entity 30 in response to the carrier query. For example, if Shipper A and Carrier C do not have a shipper-carrier contract, the transportation fee value provided with the load posting when the load posting is provided to Carrier C will be the transportation fee value provided by the shipper user when the load posting was being generated (and stored as part of the load posting in the load database 410). However, because Shipper A and Carrier B do have a shipper-carrier contract with a contract transportation fee value of $800, when a second load posting having a transportation fee value of $800 and a third load posting having a transportation fee value of $1000 are provided to the carrier computing entity 30 in response to Carrier B's carrier query, both the second load posting and the third load posting will be shown with a transportation fee value equal to the contract transportation fee value.

In various embodiments, the transportation fee value for a load posting may be determined at the time the identified one or more load postings are being filtered. For instance, a transportation fee value for a load posting may be dynamically determined (e.g., by the pricing engine). For example, the transportation fee value of a load posting may be a dynamic, automatically determined value (e.g., by the pricing engine) based on various details regarding the load, the load posting, and a shipper profile corresponding to the shipper associated with the load posting. For instance, the transportation fee value may be dynamically and/or automatically determined based on triggers such as views of the load posting by carrier users, clicks/interactions by carrier users on the load posting or similar load postings, capacity of one or more carriers, delivery time and/or time window date, contracted rates, timing, the shipper profile corresponding to the shipper, and/or the like.

After the one or more load postings are identified in response to the carrier query and then the identified one or more load postings are filtered (e.g., based on the carrier's identity and/or shipper-carrier contracts associated with the carrier), the resulting identified one or more load postings are provided. For example, the computing platform 10 may provide the filtered identified one or more load postings such that the carrier computing entity 30 receives the filtered identified one or more load postings. For instance, the carrier computing entity 30 may provide a list of the filtered identified one or more load postings via the carrier IUI 34.

At step/operation 516, a booking notification is received and the load database 410 is updated accordingly. For example, the carrier user operating the carrier computing entity 30 may review the list of filtered identified one or more load postings via the carrier IUI 34 and determine a load posting that the carrier wants to transport the corresponding load. The carrier user may then interact with the carrier IUI 34 to submit a load booking. The computing platform 10 receives the load booking that includes a load identifier that identifies the load and/or load posting, an identification of the carrier booking the load, and/or the transportation fee value that is to be paid for transportation of the load (e.g., the transportation fee value that was provided by the shipper user, a value for a dynamically determined transportation fee value, a contract transportation fee value, and/or the like). The computing platform 10 may then automatically update the load posting stored in the load database 410 to indicate that the load has been booked (e.g., by setting a flag or other indicator). Once the load is booked, the corresponding load posting will not be provided to any other carriers. For instance, the filtering engine may only identify unbooked loads in response to a carrier query.

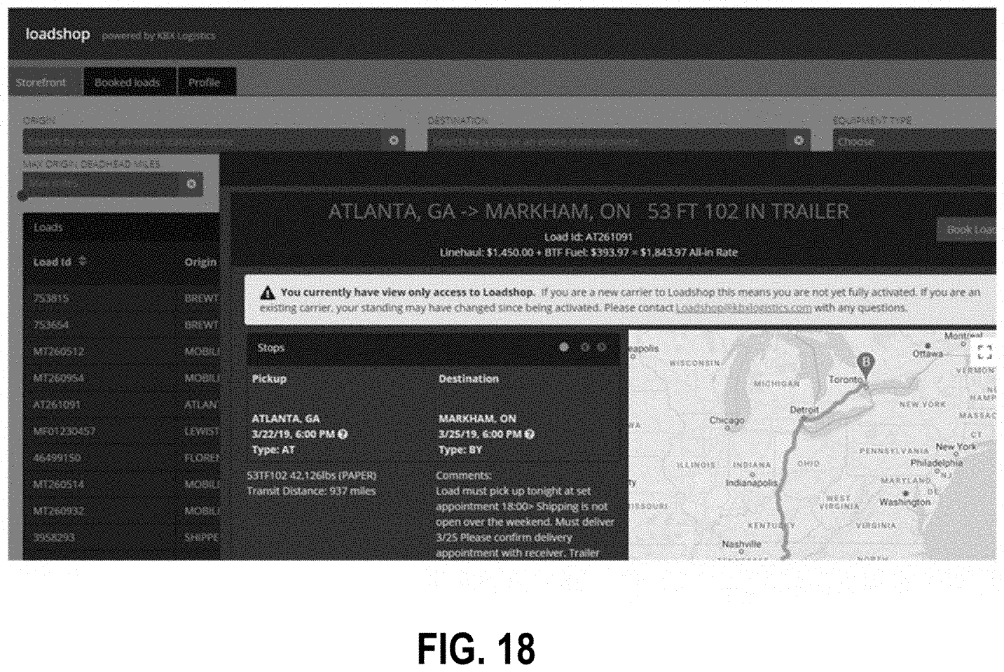

In various embodiments, as part of booking, a check may be performed in response to receiving the booking request to ensure that the carrier attempting to book the load is permitted to do so. For example, the rating for the carrier, a vetting status for the carrier, and/or other carrier profile information/data may be accessed to determine if the carrier is permitted to book the load. If the carrier is not permitted to book the load (for example because the carrier has not been vetted), the carrier IUI 34 may provide the carrier user operating the carrier computing entity 30 with a notification similar to that shown in FIG. 18.

At step/operation 518, optionally, one or more complementary loads may be identified and provided. In various embodiments, a complementary load of a first load may be a load that has a substantially opposite pick-up and delivery locations from the first load with a complementary pick-up time/window and delivery time/window. For instance, if the first load had a pick-up location of Atlanta, Ga., a delivery location of Birmingham, Ala., and a delivery time of 12 pm CT, a complementary load may have a pick-up location of Trussville, Ala., a pick-up time of 2 pm CT, and a delivery location of Doraville, Ga. In various embodiments, when a carrier user books a second load, one or more load postings corresponding to complementary loads to the second load or one or more first loads previously booked by the carrier user (or another carrier user associated with the same carrier) may be provided (e.g., via the carrier IUI) to the carrier user. For example, a first load may have a delivery location of Atlanta, Ga., and a second load may have a pick-up location of Knoxville, Tenn. In this example, a complementary load to the first load and the second load may have a pick-up location of Roswell, Ga., and a delivery location of Maryville, Tenn., with a pick-up time/window that permits the delivery of the first load to the first load delivery location, travel from the first load delivery location to the complementary load pick-up location, and any required rest (e.g., to ensure a driver (or driver team)) driving the first load, complementary load, and second load does not surpass a maximum consecutive driving time) and a delivery time/window that permits delivery of the complementary load to the associated delivery location, travel time from the complementary load delivery location to the second load pick-up location, and any required rest. A carrier profile may include information/data corresponding to carrier preferences regarding the time between the first load delivery time/window and the complementary load pick-up time/window and/or between the complementary load delivery time/window and the second load pick-up time/window used to identify complementary loads to be provided (e.g., via the carrier IUI) to a carrier user associated with the carrier corresponding to the carrier profile.

In various embodiments, one or more complementary loads may first be programmatically identified (e.g., based on one or more loads already booked by the carrier) and then filtered. For instance, the identified one or more complementary loads are filtered to only include load postings that the carrier may view and to include transportation fee values corresponding to any shipper-carrier contracts to which the carrier is a party. The filtered identified one or more complementary load postings may then be provided such that the carrier computing entity 30 receives the filtered identified one or more complementary load postings, which may then be provided via the carrier IUI 34. The carrier may then choose to book one or more complementary loads based on the filtered identified one or more complementary load postings.

At step/operation 520, the computing platform 10 may automatically monitor the transportation of the load. For example, the computing platform 10 may receive (e.g., from a shipper computing entity 20 and/or a carrier computing entity 30) information/data regarding the load being picked up, reaching one or more way points between the pickup location and the delivery location, being delivered to the delivery location, and/or the like. This may be accomplished via actual load scans, virtual load scans, GPS location information/data, movement information/data, event information/data, and/or the like. The computing platform 10 may update the load database 410 to include the information/data regarding the transportation of the load from the pick-up location to the delivery location.

At step/operation 522, it may be determined that a particular benchmark has occurred and at least a portion of the transportation fee value for the load (e.g., as agreed upon in a shipper-carrier contract, as defined by the load posting, and/or the like) is debited from the shipper account and credited to the carrier account. For instance, the computing platform 10 may cause at least a portion of the transportation fee value to be debited from the shipper account and credited to the carrier account in response to determining that a particular benchmark for transporting the load has occurred. For example, when it is determined that the carrier has picked up the load, a small portion of the transportation fee value (e.g., 5%) may be automatically debited from the shipper account and automatically credited to the carrier account. In another example, when it is determined that the carrier has delivered the load to the delivery location, the balance of the transportation fee value may be automatically debited from the shipper account and automatically credited to the carrier account. In various embodiments, the computing platform 10 may communicate with an Automated Clearing House (ACH) Network to cause the at least a portion of the transportation fee value to be debited from the shipper account and credited to the carrier account.

At step/operation 524, the shipper database 440 and/or carrier database 450 may be updated. For instance, each shipper and/or carrier may be associated with a rating and/or one or more reviews. For example, after a load has been transported by a carrier, the shipper of the load may provide a rating and/or review of the carrier (e.g., via the shipper IUI 24) and/or the carrier of the load may provide a rating and/or review of the shipper (e.g., via the carrier IUI 34). For instance, the shipper may rate the carrier based on timeliness, professionalism, how well special handling instructions were carried out, damage to the load, and/or the like. The corresponding shipper profile and/or carrier profile may be updated based on the rating and/or review. In an example embodiment, if a carrier's rating drops below a particular level, the carrier may not be allowed to book any further loads via the platform 400 until meeting various service improvement milestones (e.g., as managed by the vetting engine and/or the like).

In various embodiments, the computing platform 10 may automatically monitor how long a load posting is posted prior to the load posting being booked. In an example embodiment, if it is determined (e.g., by the computing platform 10) that a load posting has been posted for a particular amount of time (e.g., which may be a preset amount of time, may be determined based on the shipper profile, and/or the amount of time between the current time and the pick-up time/window), a load not-booked notification may be generated and provided such that a corresponding shipper computing entity 20 receives the load not-booked notification. In various embodiments, the load not-booked notification may include a load identifier for the load, the transportation fee value provided by the shipper user during the generation of the load posting, a recommended transportation fee value, an indication that the load has not yet been booked, the pick-up time/window, and/or the like. The shipper computing entity 20 may provide at least a portion of the load not-booked notification via the shipper IUI 24 and provide an opportunity for a shipper user to make changes to the load posting (e.g., changing the transportation fee value, opening up the load posting to be viewed by more carriers rather than just a preferred set of carriers, and/or the like). Any changes made to the load posting by the shipper user may be provided by the shipper computing entity 20 such that computing platform 10 receives the changes to the load posting, updates the load database 410, determines if the updated load posting satisfies the preferred load criteria of one or more carriers, and/or the like.

In some embodiments, the pricing engine 470 may be configured to generate dynamic values for transportation loads by performing predictive data analysis, for example by using a non-persistent input machine learning model. However, while various embodiments of the present invention describe performing predictive data analysis using a non-persistent input machine learning model in relation to generation dynamic values for transportation loads, a person of ordinary skill in the relevant technology will recognize that the predictive data analysis techniques discussed herein can be used to perform any predictive data analysis tasks, including any predictive data analysis tasks performed by the preferred load engine 460, the vetting engine 495, the tracking engine 485, and the filtering engine 455. For example, in some embodiments, preferred load criteria may be determined by performing predictive data analysis using a non-persistent input machine learning model.

In some embodiments, performing predictive data analysis using a non-persistent machine learning model may be accomplished in accordance with the process 2200 depicted in FIG. 22. Via the various steps/operations of the process 2200, the computing platform 10 can efficiently and effectively generate a non-persistent-input machine learning model, deploy the trained non-persistent input machine learning model, and utilize the deployed non-persistent input machine learning model to perform predictive inferences (e.g., to perform real-time predictive inferences).

In various embodiments, the platform 400 may further comprise one or more of a registration engine 490, a vetting engine 495, a filtering engine 455, a communication engine 415, a tracking/visibility engine 485, and/or the like. In various embodiments, a registration engine 490 may be configured to guide a carrier user and/or shipper user through a registration process and cause a corresponding carrier profile and/or shipper profile to be generated and stored in the appropriate database (e.g., carrier database 450 and/or shipper database 440), allow a carrier user and/or shipper user to update a carrier profile or shipper profile corresponding to an associated carrier or shipper, and/or otherwise manage carrier profiles and/or shipper profiles. In various embodiments, a vetting engine 495 may be configured to perform one or more vetting operations for carriers and/or shippers as part of the registration process and/or as part of a periodic vetting process, determine if feedback regarding a carrier or shipper indicates that a carrier or shipper should be removed from the platform and/or investigated for misconduct, and/or the like. In various embodiments, the vetting engine 495 may determine the credit worthiness of shippers and/or a dependability of carriers, such that carriers and shippers are ensured to engage in dealings with legitimate and trustworthy business entities via the platform. In various embodiments, a filtering engine 455 is configured to, for example, receive a query from a carrier computing entity 30 (e.g., provided via user interaction with a carrier IUI 34) associated with a carrier, access and search the load database 410 to identify load postings that satisfy the query (and which may be provided to the carrier), and return the identified load postings to be provided to the carrier computing entity 30. A communication engine 415 may be configured to aid in communication between a shipper and a carrier regarding a load that the shipper is shipping and the carrier is transporting. For example, the communication engine 415 may provide chat or other message-based functions or voice call functions to facilitate communication between the shipper and the carrier regarding the load being shipped by the shipper and transported by the carrier. For instance, the communication engine 415 may be configured to facilitate direct communication between the shipper and the carrier through the computing platform 10. In various embodiments, a tracking/visibility engine 485 is configured to receive location information/data (e.g., actual scans, virtual scans, GPS location information/data, movement information/data) regarding a load that is being transported and interpret, store, and provide transportation progress information/data to an associated shipper and/or carrier. As will be recognized, one or more of such engines and/or other engines may be implemented as one or more program modules, computer executable code portions, and/or the like.

### 3. Exemplary Operations of a Shipper Computing Entity

In various embodiments, a shipper computing entity 20 is configured to provide a shipper IUI 24 via a user interface of the shipper computing entity 20, receive user input (e.g., via a user input interface, such as keyboard 218 and/or the like) corresponding to a load posting, and to provide load postings such that the computing platform 10 receives the load postings. In various embodiments, the shipper client 420 operating on the computing platform 10 (and/or the shipper computing entity 20) is configured to communicate with a TMS operating on and/or accessible to the shipper computing entity 20.

In some embodiments, the shipper computing entity 20 is configured to generate a prediction output user interface, such as the prediction output user interface 2700 of FIG. 27 that is configured to display the optimal price 2701 for a particular load, based on user interface data received from the computing platform 10. While various embodiments of the present invention disclose generating price output prediction data, a person of ordinary skill in the relevant technology will recognize that prediction output user interfaces may be configured to generate non-prediction output user interfaces, such as predicted load criteria user interfaces.

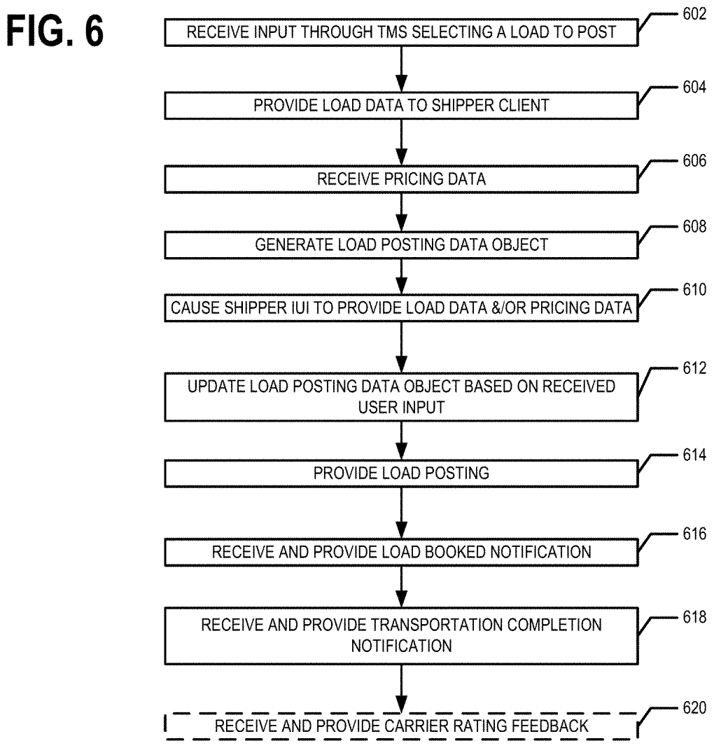

FIG. 6 provides a flowchart of processes, procedures, operations, and/or the like performed, for example by a shipper computing entity 20, to participate in the platform for transportation as a shipper of a load.

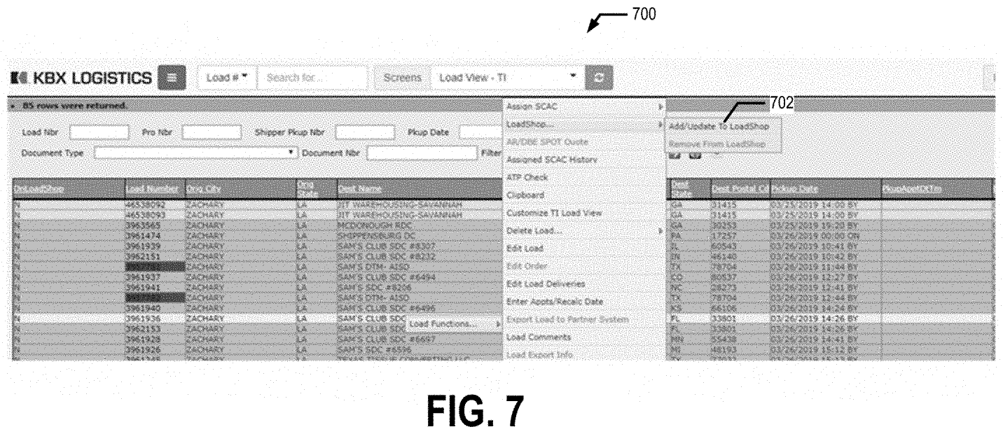

Starting at step/operation 602, input is received (e.g., via the TMS 22) identifying and/or selecting a load to post. For example, a shipper user may operate a shipper computing entity 20 to view a load in the TMS 22 and provide input (e.g., via a user input interface) to select and/or identify a load to be posted for transportation. For instance, FIG. 7 shows an example select load view 700. For example, the shipper IUI 24 and/or shipper client 420 may be integrated with the TMS 22 such that the shipper user may use a user input interface to select a post load option (shown as add/update to LoadShop option 702 in FIG. 7).

Continuing with FIG. 6, responsive to receiving the input identifying and/or selecting the load to post, the load information/data is provided to the shipper client 420, at step/operation 604. For instance, the shipper computing entity 20 may provide the load information/data to the shipper client 420 (e.g., operating on the shipper computing entity 20 and/or computing platform 10). At step/operation 606 pricing information/data is received. For example, the computing platform 10 may determine pricing information/data based on the load information/data and provide the pricing information/data such that the shipper computing entity 20 receives the pricing information/data (e.g., possibly via the shipper client 420). For instance, the pricing information/data may be a suggested transportation fee value, information/data regarding the amount of a distance-based transportation fee value portion, transportation fee value of other similar load postings, and/or the like.

At step/operation 608, a load posting information/data object is automatically generated. For example, the shipper computing entity 20 may generate a load posting information/data object comprising the load information/data for the user selected and/or identified load. For instance, the load information/data may indicate a pick-up location, pick-up time/window, delivery location, delivery time/window, special handling instructions, information/data regarding the equipment required/desired for transporting the load, and/or the like.

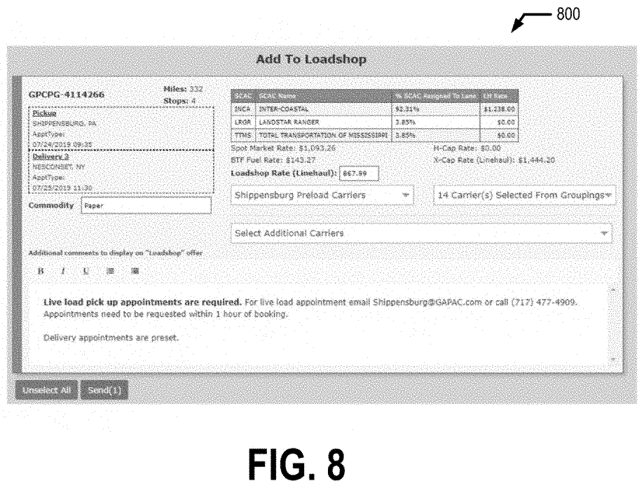

At step/operation 610, the shipper IUI 24 may provide (e.g., display) the load information/data and/or pricing information/data. For example, the shipper computing entity 20 may provide the shipper IUI providing load information/data and/or pricing information/data via a user interface of the shipper computing entity 20. FIG. 8 provides an example posting creation view 800 of the shipper IUI 24. For instance, the posting creation view 800 may provide pricing information/data corresponding to a load, the load identifier for the load, the pickup location, pick-up time/window, delivery location, delivery time/window, a distance the load is to be transported, a number of stops during the transportation of the load, an option to add additional notes, comments, and/or instructions for the transportation of the load, and/or the like.

Continuing with FIG. 6, at step/operation 612, the load posting information/data object is updated based on any user input received. For example, via the posting creation view 800, the user may enter a transportation fee value (or fee values), edit the load information/data, add special handling instructions, and/or the like by interacting with the shipper IUI 24 via a user input interface. The load posting information/data object is updated based on the received user input.

At step/operation 614, in response to receiving user input indicating that the load posting should be submitted (e.g., user selection of a submit element of the shipper IUI 24), the load posting is provided. For instance, the shipper computing entity 20 may provide the load posting information/data object such that the computing platform 10 receives the load posting information/data object.

At step/operation 616, a load booked notification is received. For example, the shipper computing entity 20 may receive a load booked notification. For instance, when a carrier books the load, the computing platform 10 may generate and provide a load booked notification. The shipper computing entity 20 may receive the load booked notification and provide at least a portion of the notification via the shipper IUI 24. For example, the shipper computing entity 20 may update the TMS 22 to indicate that the load has been booked. In an example embodiment, the load booked notification comprises the corresponding load identifier, information/data identifying the carrier that booked the load, a transportation fee value that the load was booked at, and/or the like.

At step/operation 618, a transportation completion notification is received. For instance, the shipper computing entity 20 may receive a transportation completion notification. For example, when the computing platform 10 receives an indication that the transportation of the load has been completed (e.g., from a carrier computing entity 30 and/or the like) the computing platform 10 may generate and provide a transportation completion notification. The shipper computing entity 20 may receive the transportation completion notification and provide at least a portion of the notification via the shipper IUI 24, update the TMS 22 based on the transportation completion notification, and/or the like. For instance, the shipper computing entity 20 may update the TMS 22 to indicate that the load has been delivered to the destination location. In an example embodiment, the transportation completion notification comprises the corresponding load identifier, information/data identifying the carrier that transported the load, the transportation fee value that was paid for the transportation of the load, the time at which the load was picked up, the time that the load was delivered, and/or the like.

At step/operation 620, the shipper computing entity 20 may optionally provide a shipper user with the option of providing a rating and/or review for the carrier of the load. For example, the shipper IUI 24 may provide a shipper user with a rating and/or review IUI that the shipper user may interact with (e.g., via user input interfaces) to provide a rating and/or review for the carrier that transported the load. In response to receiving user input providing a rating and/or review for the carrier that transported the load, the shipper computing entity 20 may provide the rating and/or review along with the load identifier and information/data identifying the carrier such that the computing platform 10 receives the rating and/or review along with the load identifier and information/data identifying the carrier. In various embodiments, if a rating for a carrier falls below a threshold level, the carrier may not be allowed to book any further loads via the platform 400 until meeting various service improvement milestones (e.g., as managed by the vetting engine and/or the like).

In various embodiments, a shipper may post a load via the platform 400 and offer the load to one or more carriers via other means (e.g., a broker, a different platform, and/or the like). When the shipper TMS 22 is updated to indicate that booking for a load has been obtained, the TMS 22 provides an update to the shipper client 420 to indicate that the load is no longer available. The shipper client 420 may cause the load database 410 to be updated accordingly to indicate that the corresponding load is no longer available, and the load posting will not be provided as a preferred load, complementary load, or in response to a carrier query.

### 4. Exemplary Operations of a Carrier Computing Entity

In various embodiments, a carrier computing entity 30 is configured to provide a carrier user with one or more load postings (e.g., in response to a preferred load notification/indication and/or a carrier query). The carrier computing entity 30 may be configured to receive user input selecting to book a load and communicate the booking of the load to the computing platform 10.

In some embodiments, the carrier computing entity 30 is configured to generate a prediction output user interface, such as the prediction output user interface 2700 of FIG. 27 that is configured to display the optimal price 2701 for a particular load, based on user interface data received from the computing platform 10. While various embodiments of the present invention disclose generating price output prediction data, a person of ordinary skill in the relevant technology will recognize that prediction output user interfaces may be configured to generate non-prediction output user interfaces, such as predicted load criteria user interfaces.

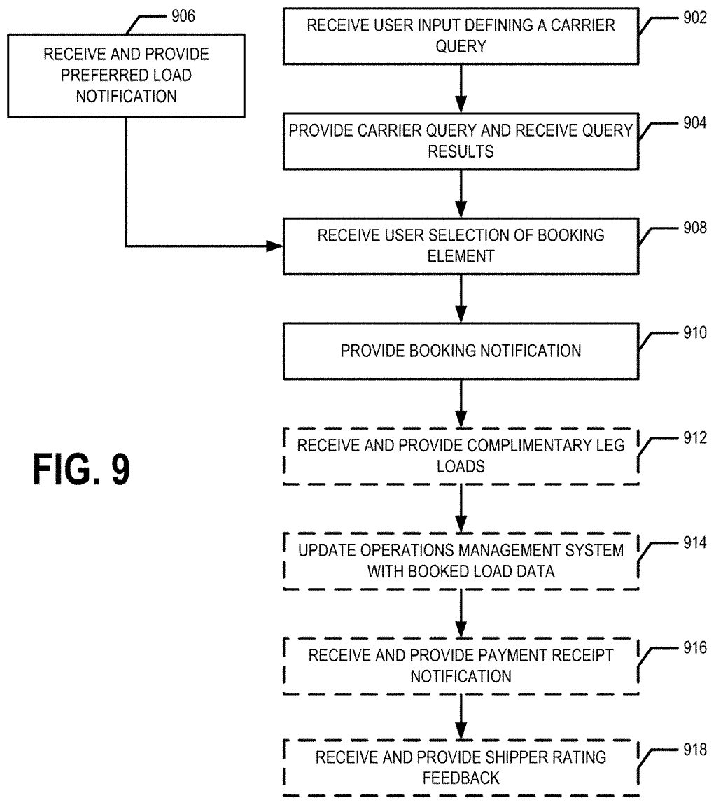

FIG. 9 provides a flowchart illustrating various process, procedures, and/or operations performed, for example by the carrier computing entity, to participate in the platform for transportation as a carrier of a load.

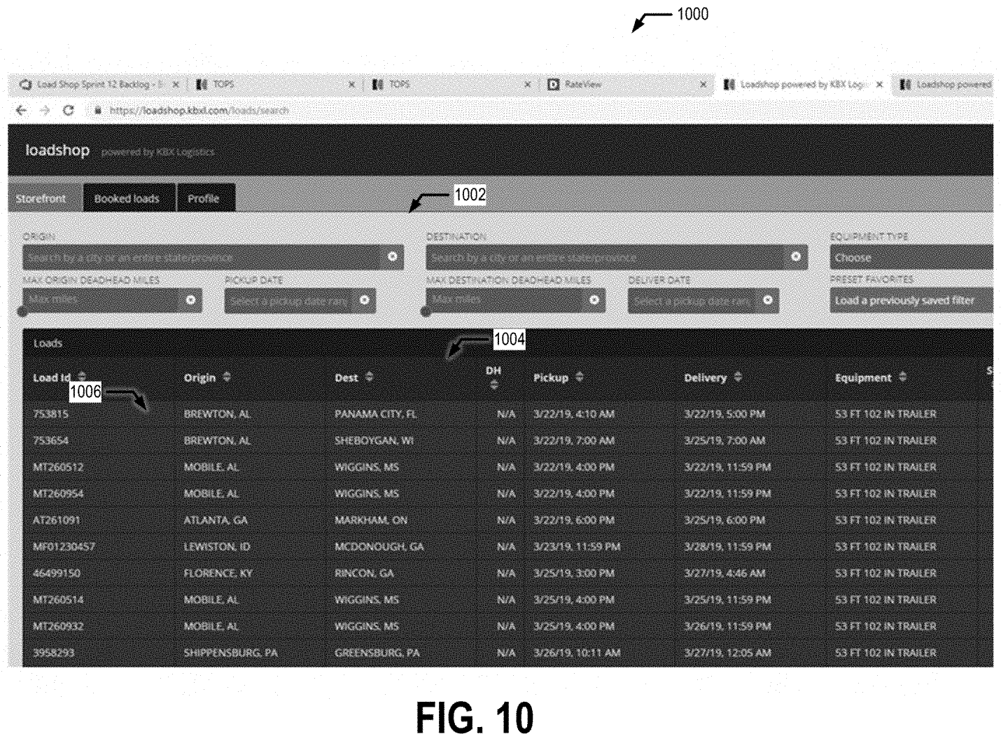

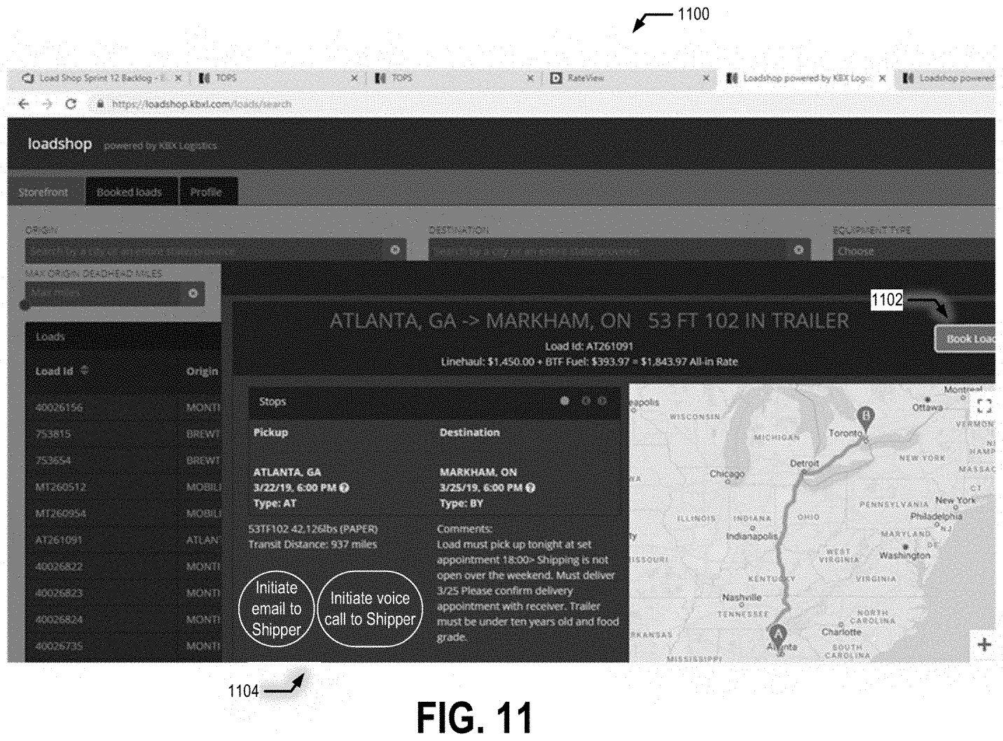

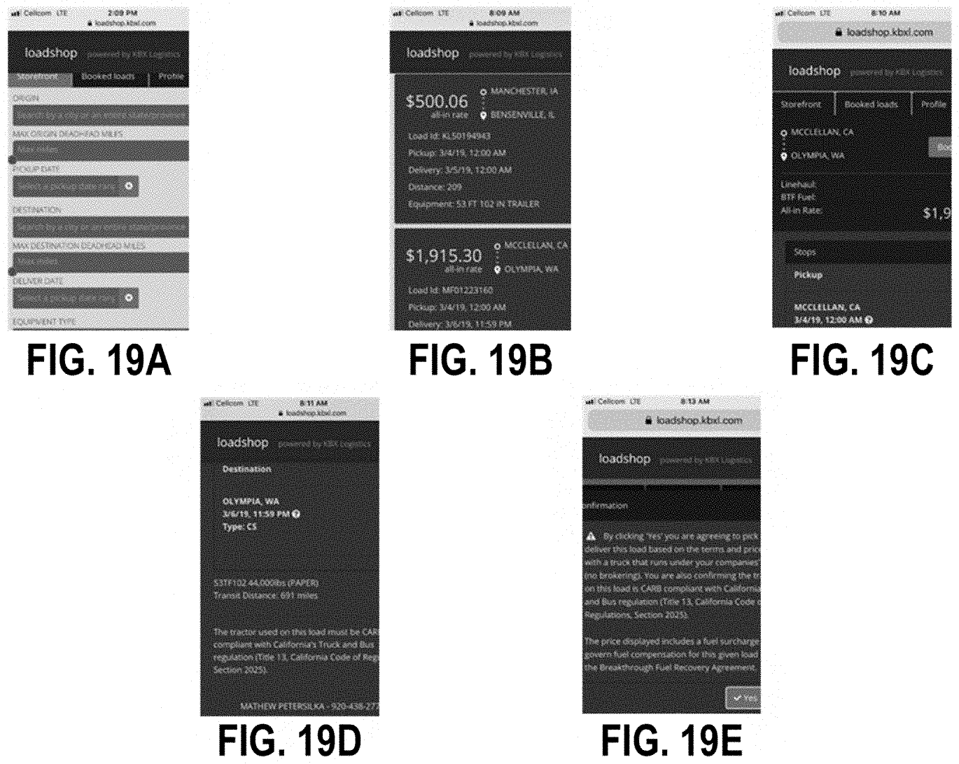

A carrier user may operate a carrier computing entity 30 to define a carrier query, at step/operation 902. For instance, a carrier user may provide user input (e.g., via a user input interface) defining a carrier query via carrier IUI 34. In various embodiments, the carrier query comprises one or more query criteria. For example, the query criteria may include a pick-up area (e.g., within a hundred miles of an address, landmark, city, and/or the like), a delivery area (e.g., within a hundred miles of an address, landmark, city, and/or the like), a pick-up and/or delivery time/window, a minimum transportation fee value, and/or the like and/or various combinations thereof. For instance, FIG. 10 provides an example query view 1000 of a carrier IUI 34. The query view 1000 comprises query generation fields 1002 that are configured for receiving user input selecting and/or providing query criteria for the carrier query. In another example, FIG. 19A provides an example mobile query view of a carrier IUI 34 operating on a carrier computing entity 30 that is a mobile computing device (e.g., a smartphone, tablet, and/or the like).

Continuing with FIG. 9, at step/operation 904, the carrier query is provided. For example, the carrier computing entity 30 may provide the carrier query such that the computing platform 10 receives the carrier query. The computing platform 10 may perform a search of the load database 410, identify one or more load postings that satisfy the query criteria of the carrier query, filter the identified one or more load postings, and provide the filtered identified one or more load postings. The carrier computing entity 30 may receive the filtered identified one or more load postings in response to the carrier query. The received load postings may be provided via the carrier IUI 34 for a carrier user operating the carrier computing entity 30 to view. For instance, the load postings portion 1004 of the query view 1000 may include a summary of one or more load postings. For example, the load postings portion 1004 of the query view 1000 may be populated with load information/data of one or more of the filtered identified one or more load postings. The carrier user may select a load summary 1006 from the load postings portion 1004 to be provided with a detailed view 1100 of the selected load posting. FIG. 19B provides an example mobile load posting view of a carrier IUI 34 operating on a carrier computing entity 30 that is a mobile computing device (e.g., a smartphone, tablet, and/or the like), where the mobile load posting view shows a list of load summaries 1006. FIGS. 19C and 19D provide example detailed views of a carrier IUI 34 operating on a carrier computing entity 30 that is a mobile computing device (e.g., a smartphone, tablet, and/or the like). The mobile detailed views provide detailed load information/data for a load posting that the carrier user selected (e.g., via input provided via a user input interface) from the list of load summaries.

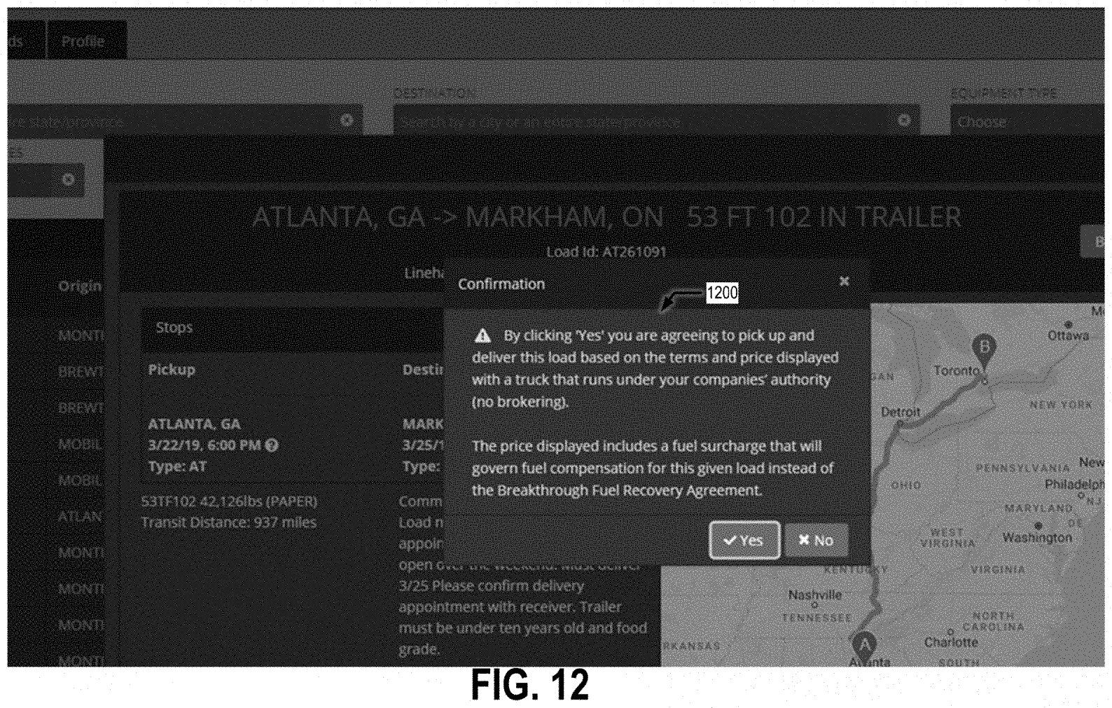

In various embodiments, a detailed view or mobile detailed view of the carrier IUI 34 includes a selectable booking element 1102. As shown in FIG. 9, at step/operation 908, the carrier computing entity 30 receives user input (e.g., via a user input interface) selecting the selectable booking element 1102. In an example embodiment, the carrier IUI 34 may provide a confirmation of the booking view, an example of which is shown in FIG. 12 (in element 1200) and FIG. 19E. The carrier user may provide user input (e.g., via the carrier IUI 34) to confirm the booking of the load. If it is determined that the carrier is not permitted to book the load, the carrier IUI may provide a message similar to that shown in FIG. 18 to inform the carrier user that the carrier is not permitted to book the load. In an example embodiment, the detailed view or mobile detailed view of the carrier IUI 34 may include one or more initiate communication elements 1104 that a carrier user may select to initiate communication with the shipper. In an example embodiment, the detailed view or mobile detailed view of the carrier IUI 34 may include contact information/data for the shipper (e.g., a phone number, email address, and/or the like).

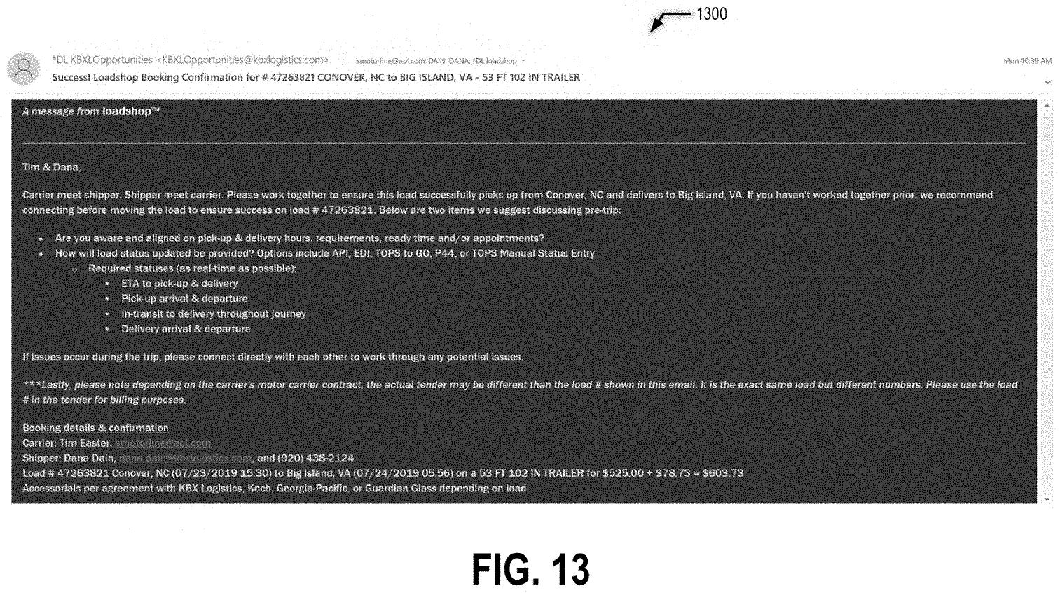

Responsive to receiving the user selection of the selectable booking element 1102 and possibly confirming the booking of the load, a booking notification is automatically generated and provided at step/operation 910. For instance, the carrier computing entity 30 may generate a booking notification and provide the booking notification such that the computing platform 10 receives the booking notification. For example, the booking notification may include the load identifier corresponding to the load posting, information/data identifying the carrier, a transportation fee value to be paid to the carrier for transporting the load, and/or the like. In response to receiving the booking notification, the computing platform may generate a booking confirmation notification. The booking confirmation notification may be provided to one or more shipper computing entities 20 (e.g., via one or more electronic destination addresses of the shipper profile) and/or to one or more carrier computing entities 30 (e.g., via one or more electronic destination addresses of the carrier profile). FIG. 13 illustrates an example booking confirmation notification 1300. As can be seen in FIG. 13, the booking confirmation notification 1300 provides contact information/data for the shipper and/or the carrier such that the shipper and carrier may initiate direct communication to assist in facilitating transportation of the load.

In an example embodiment, the complementary load postings may be received, at step/operation 912 shown in FIG. 9. For instance, the computing platform 10 may provide complementary load postings such that the carrier computing entity 30 receives the complementary load postings in response to carrier booking a load. The carrier computing entity 30 may receive the complementary load postings and provide at least a summary of the complementary load postings via the carrier IUI 34. In an example embodiment, the carrier user may select one or more complementary loads and view a detailed version of the complementary load posting, book a complementary load, and/or the like.

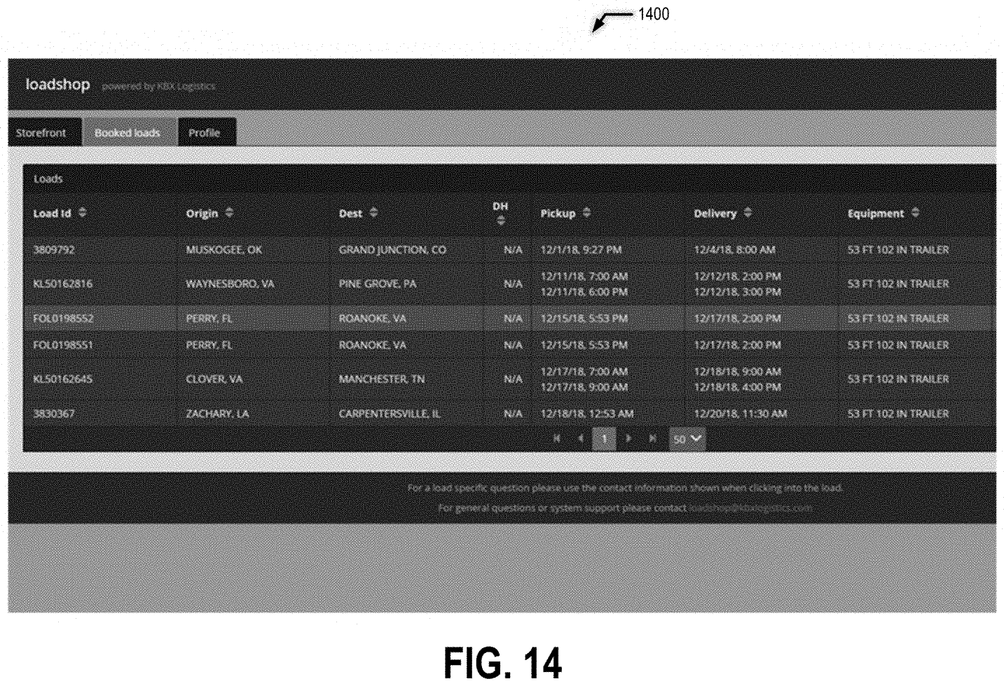

In an example embodiment, at step/operation 914, the OMS 32 may be updated based on the one or more booked loads. For example, the carrier computing entity 30 may cause the OMS 32 to be updated based on the one or more booked loads. For instance, the carrier client 430 may interact with the OMS 32 (e.g., as a plug in, via one or more API calls, and/or the like) to cause the OMS 32 to be updated based on the one or more booked loads. In an example embodiment, the carrier IUI may provide a booked loads view 1400, an example of which is shown in FIG. 14. For example, the booked loads view 1400 may provide summaries of the loads booked by the carrier. In an example embodiment, a carrier user may provide input selecting one of the booked load summaries shown in the booked loads view 1400 to be provided with detailed information/data regarding the booked load, including a status of the booked load (e.g., confirming booking with shipper, en route to pick up, load picked up, load being transported, load delivered, load checked in by receiver, payment received, and/or the like).

Continuing with FIG. 9, at step/operation 916, after completion of one or more benchmarks, milestones, and/or thresholds of transporting the load, at least a portion of a transportation fee value may be automatically debited from the shipper account and automatically credited to the carrier account. A payment notification/indication may be generated (e.g., by the computing platform 10) and provided such that the carrier computing entity 30 receives the payment notification/indication. For instance, the payment notification/indication may be provided via the carrier IUI 34. In an example embodiment, the payment notification/indication comprises the load identifier identifying the load corresponding to the payment, the amount of the payment, an indication of the benchmark reached, a timestamp of the financial interaction, and/or the like. In various embodiments, the total amount debited from the shipper account may be slightly larger than the transportation fee value for the load. For example, the shipper may pay a nominal transaction fee (e.g., 3-5% of the transportation fee value, a set value (e.g., $25-$100)), and/or the like) for use of the platform 400 in coordinating the transportation of the load.

At step/operation 918, the carrier computing entity 30 may optionally provide a carrier user with the option of providing a rating and/or review for the shipper of the load. For instance, the carrier IUI 34 may provide a carrier user with a rating and/or review IUI that the carrier user may interact with (e.g., via user input interfaces) to provide a rating and/or review for the shipper that shipped the load. In response to receiving user input providing a rating and/or review for the shipper that shipped the load, the carrier computing entity 30 may provide the rating and/or review along with the load identifier and information/data identifying the shipper such that the computing platform 10 receives the rating and/or review along with the load identifier and information/data identifying the shipper.

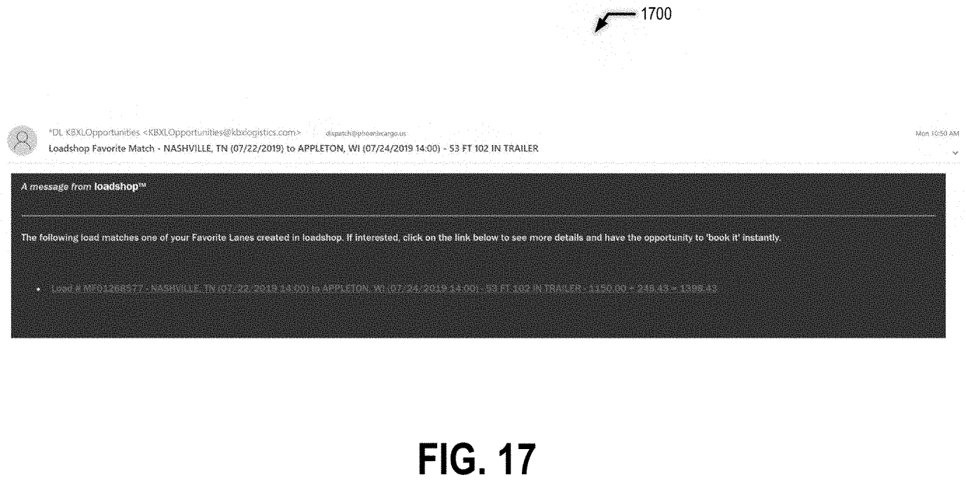

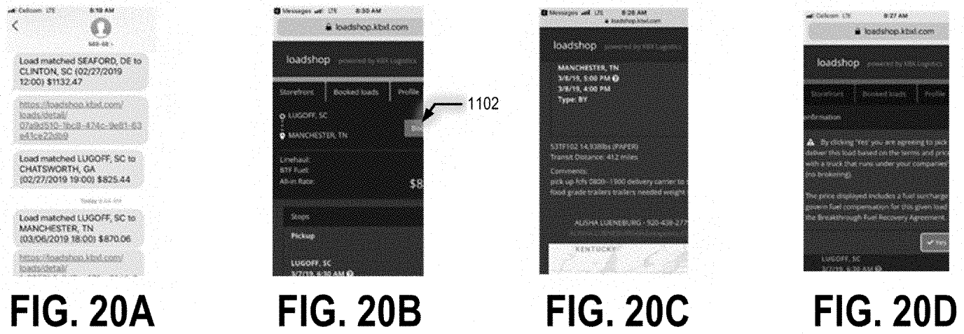

In various embodiments, a carrier user may view a load posting provided as part of a preferred load notification/indication. For example, at step/operation 906 of FIG. 9, the carrier computing entity 30 may receive a preferred load notification/indication. In various embodiments, the preferred load notification/indication may be provided to an electronic destination address (e.g., email, text message, SMS, MMS, instant messenger handle, and/or the like). FIGS. 17 and 20A illustrate example preferred load notification/indication views 1700. For instance, a preferred load notification/indication view 1700 may include a link that the carrier user may select to view the load posting for the preferred load. Responsive to receiving user input selecting the link, the carrier computing entity 30 provides a detailed view or mobile detailed view of the corresponding load posting (e.g., via the carrier IUI 34). FIGS. 20B and 20C show example mobile detailed view of a preferred load posting. The carrier user may then decide to book the load or not book the load. If the carrier user decides to book the load, the carrier user may provide input selecting a selectable booking element 1102 and may be asked to confirm the booking of the load, as shown in FIG. 20D.

### 5. Additional Features/Advantages

Various embodiments of the present invention provide significant technical advantages and address technical challenges of providing a platform for transportation. In particular, the platform for transportation is configured to integrate with a shipper's TMS and/or a carrier's OMS to reduce the need for manual entry of information. Various embodiments provide for dynamically and automatically determining a transportation fee value (and/or a suggestion thereof) to be paid by the shipper to the carrier for transportation of the load. The dynamic determination of the transportation fee value to be provided to a carrier as part of the load posting allows for dynamic market features to be reflected in real-time or near real-time in the provided transportation fee values. Various embodiments provide further advantages of providing carrier users with notification when a load that satisfies a carrier's preferred load criteria is posted and/or providing carrier users with complementary load postings that complement loads already booked by the carrier. Moreover, only load postings for loads that have not yet been booked are provided to carrier users such that a carrier user does not waste time and/or resources determining whether or not to book allowed that is not actually available for booking. The advantages provided by various embodiments are provided via technical means such as the carrier IUI, shipper IUI, and various engines of the platform 400 that are provided via the execution of computer executable code by the processing element 105.

Moreover, various embodiments of the present invention provide techniques for performing predictive data analysis using non-persistent-input data that increase the efficiency and reliability of such non-persistent-input machine learning models. A non-persistent-input machine learning task is a machine learning model task that includes training and/or utilizing a machine learning model using training data derived based at least in part using data extracted from at least one periodically updated data source. Because of the non-persistent nature of the input training data for noted non-persistent-input machine learning models, training and utilizing such non-persistent-input machine learning models presents unique challenges in terms of both appropriately adjusting the timing of retrieval of periodically updated as well as setting the temporality of the persistently updated data in order to provide temporal compatibility across the periodically updated data and persistently updated data. Absent such complex temporal adjustments, the proposed machine learning frameworks will have substantial efficiency challenges and reliability challenges, as they will be unable to capture temporal relationships of real-world data that is hidden by lack of persistent access to data and will require a greater number of training iterations in order to train sufficiently accurate models.

To address the above-described challenges associated with efficiency and reliability of performing predictive data analysis using non-persistent input data, various embodiments of the present invention introduce techniques that retrieve both persistently updated training data and non-persistently updated training data (e.g., periodically updated training data) in accordance with the latest availability time of the non-persistently updated training data sources. For example, in some embodiments, at a latest availability time of the non-persistently updated training data sources, such non-persistently-updated training data is joined with persistently updated training data having timestamps that predate the latest availability time in order to generate a non-persistent-input machine learning model. The resulting machine learning model is thus only trained only on a portion of the persistently updated training data that would have been generated by the latest update time of the non-persistently updated training data.

By utilizing the above-noted techniques for training a non-persistent-input machine learning model using only on a portion of the persistently updated training data that would have been generated by the latest update time of the non-persistently updated training data, various embodiments of the present invention disclose a framework for imposing temporal restrictions on training input data that causes such training input data to accurately reflect real-world temporal relationships. As described above, this in turn causes resulting non-persistent-input machine learning model to be both more efficient to train and more accurate once trained. Thus, by using various innovative and technologically adventurous aspects of the present invention, a predictive data analysis framework can increase the efficiency and reliability of non-persistent-input machine learning models. Accordingly, various embodiments of the present invention make substantial technical contributions to the fields of predictive data analysis architectures and machine learning architectures by disclose techniques for substantially improving the efficiency and reliability of non-persistent-input machine learning models.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation

1. A computer-implemented method for performing predictive data analysis using a non-persistent-input machine learning model, the computer-implemented method comprising:
at an availability time associated with a plurality of periodically updated data sources, retrieving a plurality of periodically updated data objects from the plurality of periodically updated data sources;
performing an aggregate join operation across the plurality of periodically updated data objects to generate an updated joined periodic data object;
updating a joined periodic data object in a storage medium based, at least in part, on the updated joined periodic data object;
causing a triggering event detection data object to detect one or more qualified updates to the joined periodic data object and, in response to detecting the one or more qualified updates, generate a training trigger event data object, wherein the training event data object defines a persistent data time window for one or more persistently updated data sources;
generating a persistently updated data object by retrieving data from the one or more persistently updated data sources in accordance with the persistent data time window;
generating the non-persistent-input machine learning model based, at least in part, on the persistently updated training data object and the joined periodic data object; and
deploying the non-persistent-input machine learning model for performing one or more predictive inferences to generate one or more predictions and for performing one or more prediction-based actions based, at least in part, on the one or more predictions.

2. The computer-implemented method of claim 1, wherein the persistent data time window is determined based, at least in part, on the availability time.

3. The computer-implemented method of claim 1, wherein the availability time of the plurality of periodically updated data sources is determined to be subsequent to each per-data-source availability time for a periodically updated data source of the plurality of periodically updated data sources.

4. The computer-implemented method of claim 1, wherein:
the training event data object further defines one or more training configuration properties for generating the non-persistent-input machine learning model; and
generating the non-persistent-input machine learning model is performed based, at least in part, on the one or more training configuration properties.

5. The computer-implemented method of claim 1, wherein deploying the non-persistent-input machine learning model comprises:
causing a model deployment routine that is configured to generate a deployed model data object on a machine learning platform and to provide an end-point configuration data object for the deployed model data object.

6. The computer-implemented method of claim 5, wherein performing the one or more predictive inferences comprises:
causing a predictive inference routine to trigger the end-point configuration data object to process an input periodic data object and an input persistent data object in accordance with the deployed model data object to generate the one or more predictions.

7. The computer-implemented method of claim 1, wherein detecting a qualified update of the one or more qualified updates comprises:
determining an occurred update to the joined periodic data object, and
determining whether the occurred update conforms to one or more update qualification criteria.

8. The computer-implemented method of claim 1, further comprising:
storing one or more load postings in a load database;
responsive to at least one of (a) determining that a first load posting of the one or more load postings satisfies load preference criteria of a carrier or (b) determining that the first load posting satisfies query criteria of a carrier query received from the carrier, automatically identifying a shipper associated with the load posting;
determining whether a shipper-carrier contract is in place between the shipper and the carrier;
responsive to determining that a shipper-carrier contract is in place between the shipper and the carrier:
identifying a contract transportation fee value based on the one or more predictive inferences,
responsive to determining that the contract transportation fee value is equal to or less than a transportation fee value of the first load posting, providing the first load posting with the contract transportation fee value, and
responsive to determining that the contract transportation fee value is greater than the transportation fee value of the first load posting, not providing the first load posting; and
responsive to determining that there is not a shipper-carrier contract in place between the shipper and the carrier, providing the first load posting with the transportation fee value of the load posting, wherein the load posting is provided such that a carrier computing entity receives the load posting and provides the load posting via an interactive user interface.

9. The computer implemented method of claim 8, further comprising:
receiving, originating from the carrier computing entity, a booking notification comprising a load identifier corresponding to the load posting; and
updating the load database to indicate that the load posting is booked, wherein when a load posting is indicated as booked, the load posting is not provided to any further carriers.

10. The computer implemented method of claim 9, further comprising:
identifying one or more complementary loads based on the load posting and providing complementary load postings corresponding to the identifying one or more complementary loads to the carrier computing entity.

11. The computer-implemented method of claim 1, further comprising:
storing one or more carrier profiles in a carrier database, each of the one or more carrier profiles comprising preferred load criteria, wherein the preferred load criteria are determined based on the one or more predictive inferences;
receiving a load posting;
determining based on preferred load criteria of a first carrier profile whether the load posting satisfies the preferred load criteria;
responsive to a determination that the load posting satisfies the preferred load criteria, generating and providing a preferred load notification/indication, wherein the preferred load notification/indication is provided such that a carrier computing entity associated with a carrier corresponding to the first carrier profile receives the preferred load notification/indication, the preferred load notification/indication comprising a link to the load posting; and
responsive to a determination that the load posting does not satisfy the preferred load criteria, not generating and providing the preferred load notification/indication.

12. The computer implemented method of claim 11, wherein the preferred load criteria include one or more of a pick-up area, a delivery area, a day of the week, a minimum transportation fee value, or an equipment type.

13. The computer implemented method of claim 1, further comprising:
receiving load information/data corresponding to a first load, the load information/data comprising a pick-up time/window, wherein the pick-up time/window is determined based on the one or more predictive inferences;
identifying one or more load postings stored in a load database that are similar to the first load, wherein a load posting stored in the load database is similar to the first load if at least one of (a) a transportation path of a load posting at least partially overlaps a transportation path for the first load, the transportation path being a route from a pick-up location of a load to a delivery location of a load or (b) a transportation period of the load posting at least partially overlaps a transportation period for the first load, the transportation period being the time period between a pick-up time/window for the load and a delivery time/window for the load;
accessing transportation fee values from the identified one or more load postings;
based on at least one of (a) the transportation fee values, (b) an amount of time between a current time and the pick-up time/window, or (c) a volume of load postings having overlapping transportation periods that at least partially overlap with the transportation period of the first load, determining a suggested transportation fee value for the first load; and
providing the suggested transportation fee value such that a shipper computing entity receives the suggested transportation fee value and provides the suggested transportation fee value via a shipper interactive user interface.

14. The computer implemented method of claim 12, further comprising receiving a load posting information/data object comprising a transportation fee value for the first load and storing a load posting based on the load posting information/data object within the load database.

15. The computer implemented method of claim 12, further comprising receiving a load posting information/data object corresponding to the first load and comprising an indication that a transportation fee value for the first load is to be dynamically determined and storing a load posting based on the load posting information/data object within the database.

16. The computer implemented method of claim 14, further comprising providing the load posting to a carrier computing entity associated with a carrier, wherein providing the load posting to the carrier computing entity comprises:
determining whether a shipper-carrier contract is in place between a shipper of the first load and the carrier;
responsive to a determination that the shipper-carrier contract is in place between the shipper and the carrier, determining a contract transportation fee value associated with the shipper-carrier contract and providing the load posting with the contract transportation fee value; and
responsive to a determination that there is not a shipper-carrier contract in place between the shipper and the carrier, determining a dynamic transportation fee value for the first load and providing the load posting with the dynamic transportation fee value.

17. The computer implemented method of claim 15, wherein the dynamic transportation fee value is determined based on one or more of (a) transportation fee values associated with one or more load postings having at least partially overlapping transportation paths, (b) transportation fee values associated with one or more load postings having at least partially overlapping transportation periods, (c) an amount of time between the current time and the pick-up time/window, (d) a volume of load postings having transportation periods that at least partially overlap with the transportation period of the first load, (e) a volume of load postings having transportation paths that at least partially overlap with the transportation path of the first load, (f) a number of times the load posting corresponding to the first load has been provided to a carrier computing entity, (g) a rating associated with the shipper, or (h) a rating associated with the carrier.

18. The computer implemented method of claim 12, wherein the suggested transportation value is determined based on shipper ranking for a shipper of the first load.

19. A computer program product for performing predictive data analysis using a non-persistent-input machine learning model, the computer program product comprising at least one non-transitory computer-readable storage medium having computer-readable program code portions stored therein, the computer-readable program code portions configured to:
at an availability time associated with a plurality of periodically updated data sources, retrieve a plurality of periodically updated data objects from the plurality of periodically updated data sources;
perform an aggregate join operation across the plurality of periodically updated data objects to generate an updated joined periodic data object;
update a joined periodic data object in a storage medium based, at least in part, on the updated joined periodic data object;
cause a triggering event detection data object to detect one or more qualified updates to the joined periodic data object and, in response to detecting the one or more qualified updates, generate a training trigger event data object, wherein the training event data object defines a persistent data time window for one or more persistently updated data sources;
generate a persistently updated data object by retrieving data from the one or more persistently updated data sources in accordance with the persistent data time window;
generate the non-persistent-input machine learning model based, at least in part, on the persistently updated training data object and the joined periodic data object; and
deploy the non-persistent-input machine learning model for performing one or more predictive inferences to generate one or more predictions and for performing one or more prediction-based actions based, at least in part, on the one or more predictions.

20. An apparatus for performing predictive data analysis using a non-persistent-input machine learning model, the apparatus comprising at least one processor and at least one memory including program code, the program code configured to, with the processor, cause the apparatus to at least:
at an availability time associated with a plurality of periodically updated data sources, retrieve a plurality of periodically updated data objects from the plurality of periodically updated data sources;
perform an aggregate join operation across the plurality of periodically updated data objects to generate an updated joined periodic data object;
update a joined periodic data object in a storage medium based, at least in part, on the updated joined periodic data object;
cause a triggering event detection data object to detect one or more qualified updates to the joined periodic data object and, in response to detecting the one or more qualified updates, generate a training trigger event data object, wherein the training event data object defines a persistent data time window for one or more persistently updated data sources;
generate a persistently updated data object by retrieving data from the one or more persistently updated data sources in accordance with the persistent data time window;
generate the non-persistent-input machine learning model based, at least in part, on the persistently updated training data object and the joined periodic data object; and
deploy the non-persistent-input machine learning model for performing one or more predictive inferences to generate one or more predictions and for performing one or more prediction-based actions based, at least in part, on the one or more predictions.
